(19) United States
(12) Patent Application Publication
(10) Pub. No.: US 2026/0268744 A1
(43) Pub. Date: Sep. 10, 2026

(54) PRIZE ACQUISITION GAME DEVICE

(71) Applicant: SEGA CORPORATION, Tokyo (JP)

(72) Inventors: Shinya Goto, Tokyo (JP); Hyeonsik Kim, Tokyo (JP); Midori Yamazaki, Tokyo (JP); Keisuke Tsukahara, Tokyo (JP); Keigo Inuyama, Tokyo (JP)

(73) Assignee: SEGA CORPORATION, Tokyo (JP)

(21) Appl. No.: 19/660,670

(22) Filed: Apr. 28, 2026

Related U.S. Application Data
(63) Continuation of application No. PCT/JP2024/037383, filed on Oct. 21, 2024.

(30) Foreign Application Priority Data
Nov. 1, 2023 (JP) 2023-187865

(51) Int. Cl. G07F 17/32

(52) U.S. Cl. CPC G07F 17/3297; G07F 17/3211

(57) ABSTRACT

A prize acquisition game device that allows a player to play a game to acquire a prize accommodated in an accommodation space, including: a prize catcher that catches the prize accommodated in the accommodation space; and a prize exhibit unit that is disposed inside and at a rear portion of the accommodation space to display the prize, and that includes: a partition body that partitions the accommodation space in a left-right direction of the prize acquisition game device and is configured to be movable in the left-right direction.

### TECHNICAL FIELD

The present invention relates to a prize acquisition game device that accommodates a prize in an accommodation space and allows a player to play a game to acquire the prize.

### DESCRIPTION OF RELATED ART

There are various types of prize acquisition game devices that allow a player to play a game to acquire a prize by moving a prize acquisition unit within an accommodation space which accommodates the prize (for example, see Patent Documents 1 and 2).

### PATENT DOCUMENTS

Patent Document 1: Japanese Unexamined Patent Publication No. 2014-4176

Patent Document 2: Japanese Unexamined Patent Publication No. 2019-98076

### TECHNOLOGICAL PROBLEM TO BE SOLVED BY INVENTION

In the prize acquisition game devices described in Patent Documents 1 and 2, two areas are provided on the left and right sides thereof as areas where a player plays a prize acquisition game, and in particular, in the prize acquisition game device described in Patent Document 1, prize display shelves are provided in each play area. In these prize acquisition game devices, when different types of prizes are displayed in each play area or prize display shelf, only limited arrangements are possible.

### SUMMARY

One or more embodiments of the present invention provide a prize acquisition game device configured to be able to change the size of a play area or a prize exhibit unit depending on the type of a prize.

According to an aspect of the present invention, there is provided a prize acquisition game device that allows a player to play a game to acquire a prize accommodated in an accommodation space, comprising;

a prize catcher that catches the prize accommodated in the accommodation space; and

a prize exhibit unit that is disposed inside and at a rear portion of the accommodation space to display the prize, and that comprises: a partition body that partitions the accommodation space in a left-right direction of the prize acquisition game device and is configured to be movable in the left-right direction.

According to the feature, by moving the partition body for partitioning the accommodation space in the left-right direction, the left-right width of each play area, prize exhibit unit, or the like can be freely changed depending on the type of the prize.

In the prize acquisition game device according to the aspect of the present invention,

the accommodation space includes, in addition to the prize exhibit unit disposed at the rear portion, a play area disposed at a front portion of the accommodation space, and the partition body partitions, in the left-right direction, at least the prize exhibit unit in the accommodation space.

According to the feature, the width of the prize exhibit unit can be changed depending on the type of the prize.

In the prize acquisition game device according to the aspect of the present invention,

the partition body includes: a first partition extending in an up-down direction of the prize acquisition game device to partition the prize exhibit unit, and a second partition extending in a front-rear direction of the prize acquisition game device to partition the play area.

According to the feature, the strength of the partition body can be increased.

In the prize acquisition game device according to the aspect of the present invention,

the partition body is fixed at a rear upper part or a rear lower part of the accommodation space.

According to the feature, there is no need to process the partition body at the rear portion of the accommodation space in accordance with a position where the partition body has been moved, thereby improving the appearance of the rear portion of the accommodation space.

In the prize acquisition game device according to the aspect of the present invention,

a guide rail extending in the left-right direction is disposed at the rear upper part of the accommodation space, and an upper part of the partition body is slidably suspended from the guide rail.

According to the feature, the partition body can be safely moved in the left-right direction with a small amount of force.

In the prize acquisition game device according to the aspect of the present invention,

the prize exhibit unit further comprises a prize support body having one end supported by the partition body, and the prize support body is configured to have an adjustable length in the left-right direction.

According to the feature, the left-right width of the prize support body can also be changed in accordance with the change in the left-right width of the prize exhibit unit due to the movement of the partition body.

In the prize acquisition game device according to the aspect of the present invention,

the prize support body is a rod-shaped member configured to be extendable and retractable in the left-right direction.

According to the feature, the left-right width of the prize support body can be changed with a simple structure.

### BRIEF DESCRIPTION OF THE DRAWINGS

FIG. 1 is an external view illustrating a configuration of a prize acquisition game device according to one or more embodiments.

FIG. 2 is a schematic perspective view illustrating a configuration of the prize acquisition game device according to one or more embodiments.

FIG. 3 is a block diagram illustrating a configuration of the prize acquisition game device according to one or more embodiments.

FIG. 4 is a schematic view illustrating a configuration of a prize acquisition unit according to one or more embodiments.

FIG. 5 is a schematic perspective view illustrating a configuration of a moving unit according to one or more embodiments.

FIG. 6 is a top-surface side perspective view illustrating a configuration of the moving unit according to one or more embodiments.

FIG. 7 is a right-surface side perspective view illustrating a configuration of the moving unit according to one or more embodiments.

FIG. 8 is a schematic perspective view illustrating a configuration of a first right end actuating unit according to one or more embodiments.

FIG. 9 is a schematic perspective view illustrating a configuration of a second left end actuating unit according to one or more embodiments.

FIG. 10 is a view illustrating a state where the first right end actuating unit and the second left end actuating unit have been moved to the right side.

FIG. 11 is a view illustrating a state where the first right end actuating unit has been moved to the left side and the second left end actuating unit has been moved to the right side.

FIG. 12A is a view explaining the settings of play areas and illustrating a state where a first play area PA1 and a second play area PA2 are set to the same size.

FIG. 12B is a view explaining the settings of play areas and illustrating a state where the second play area PA2 is set to be smaller than the first play area PA1.

FIG. 12C is a view explaining the settings of play areas and illustrating a state where a non-play area DA is set between the first play area PA1 and the second play area PA2.

FIG. 13 is a flowchart explaining an operation example of the prize acquisition game device according to one or more embodiments.

FIG. 14 is a schematic perspective view illustrating a partition body and a prize exhibit unit in an accommodation space.

FIG. 15A is a plan view illustrating the partition body and the prize exhibit unit in the accommodation space of FIG. 14.

FIG. 15B is a front view.

FIG. 16 is a vertical cross-sectional view illustrating the partition body and the prize exhibit unit in the accommodation space of FIG. 14.

FIG. 17 is a cross-sectional view taken along line A-A of FIG. 15B.

FIG. 18 is a cross-sectional view taken along line B-B of FIG. 15B.

FIG. 19A is a cross-sectional view taken along line C-C of FIG. 15A.

FIG. 19B is a view illustrating a change in the position of a rod-shaped member.

FIG. 20A is a perspective view illustrating a state where a left end portion of the rod-shaped member is held in a first partition.

FIG. 20B is a perspective view illustrating a state where a right end portion of the rod-shaped member is held in a side holding portion.

FIG. 21A is a cross-sectional view taken along line D-D of FIG. 15B.

FIG. 21B is a view showing a state where a mounting position of the first partition has been changed.

FIG. 22 is a cross-sectional view taken along line E-E of FIG. 16.

FIG. 23A is a schematic plan view illustrating the prize exhibit unit in a state where the partition body is disposed at the center position in the left-right direction.

FIG. 23B is a schematic plan view illustrating the prize exhibit unit in a state where the partition body is disposed at the right side of the center position.

FIG. 23C is a schematic plan view illustrating the prize exhibit unit in a state where the partition body is disposed at the left side of the center position.

FIG. 24 is a schematic perspective view illustrating a partition body and a prize exhibit unit as a modified example of the present invention.

FIG. 25 is a schematic view illustrating a guide rail as the modified example of the present invention.

FIG. 26A is a cross-sectional view illustrating a holding structure for a prize support body as the modified example of the present invention.

FIG. 26B is a cross-sectional view illustrating a holding structure for a prize support body as the modified example of the present invention.

FIG. 26C is a schematic view illustrating a holding structure for a prize support body as another modified example of the present invention.

FIG. 27 is a schematic perspective view illustrating a prize support body as another modified example of the present invention.

FIG. 28 is a schematic perspective view illustrating a configuration of an actuating unit according to one or more embodiments.

### DETAILED DESCRIPTION OF EMBODIMENTS

A prize acquisition game device according to one or more embodiments allows a player to play a game to acquire a prize accommodated in an accommodation space, the prize acquisition game device comprising:

a prize catcher that catches the prize accommodated in the accommodation space; and

a prize exhibit unit that is disposed inside and at a rear portion of the accommodation space to display the prize, and that comprises: a partition body that partitions the accommodation space in a left-right direction of the prize acquisition game device and is configured to be movable in the left-right direction.

According to the feature, by moving the partition body for partitioning the accommodation space in the left-right direction, the left-right width of each play area or prize exhibit unit can be freely changed depending on the type of the prize.

In the prize acquisition game device according to one or more embodiments,

the accommodation space includes, in addition to the prize exhibit unit disposed at the rear portion, a play area disposed at a front portion of the accommodation space, and the partition body partitions, in the left-right direction, at least the prize exhibit unit in the accommodation space.

According to the feature, the width of the prize exhibit unit can be changed depending on the type of the prize.

In the prize acquisition game device according to one or more embodiments of the present invention,

the partition body includes: a first partition extending in an up-down direction of the prize acquisition game device to partition the prize exhibit unit, and a second partition extending in a front-rear direction of the prize acquisition game device to partition the play area.

According to the feature, the strength of the partition body can be increased.

In the prize acquisition game device according to one or more embodiments,

at least a part of an end surface of the partition body emits light.

According to the feature, even if the width of the play area or prize exhibit unit is changed by moving the partition body, the boundary can be clearly recognized.

In the prize acquisition game device according to one or more embodiments,

the partition body is fixed at a rear upper part or a rear lower part of the accommodation space.

According to the feature, there is no need to process the partition body at the rear portion of the accommodation space in accordance with a position where the partition body has been moved, thereby improving the appearance of the rear portion of the accommodation space.

In the prize acquisition game device according to one or more embodiments,

a guide rail extending in the left-right direction is disposed at the rear upper part of the accommodation space, and an upper part of the partition body is slidably suspended from the guide rail.

According to the feature, the partition body can be safely moved in the left-right direction with a small amount of force.

In the prize acquisition game device according to one or more embodiments,

the prize exhibit unit further comprises a prize support body having one end supported by the partition body, and the prize support body is configured to have an adjustable length in the left-right direction.

According to the feature, the left-right width of the prize support body can also be changed in accordance with the change in the left-right width of the prize exhibit unit due to the movement of the partition body.

In the prize acquisition game device according to one or more embodiments,

the prize support body is a rod-shaped member configured to be extendable and retractable in the left-right direction.

According to the feature, the left-right width of the prize support body can be changed with a simple structure.

In the prize acquisition game device according to one or more embodiments,

the prize support body is installed between the partition body and holding bodies disposed on the left and right sides of the accommodation space.

According to the feature, the prize support body can be installed at different positions between the partition body and the holding bodies.

In the prize acquisition game device according to one or more embodiments,

a plurality of hole portions is formed in the partition body and the holding bodies, and both ends of the prize support body are locked in the hole portions of the partition body and the holding bodies.

According to the feature, the position of the prize support body can be easily changed.

In the prize acquisition game device according to one or more embodiments,

locking portions are formed on both ends of the prize support body to restrict the prize support body from falling out of the hole portions.

According to the feature, it is possible to prevent the prize support body from falling out.

The prize acquisition game device according to one or more embodiments

includes a movement restriction portion that restricts the prize support body from moving outward of the partition body or the holding body.

According to the feature, it is possible to prevent contact between the prize support body and adjacent members such as transparent plates that form the accommodation space.

Hereinafter, the prize acquisition game device according to the present invention will be described with reference to the embodiments.

### Embodiments

### Configuration of Prize Acquisition Game Device 1

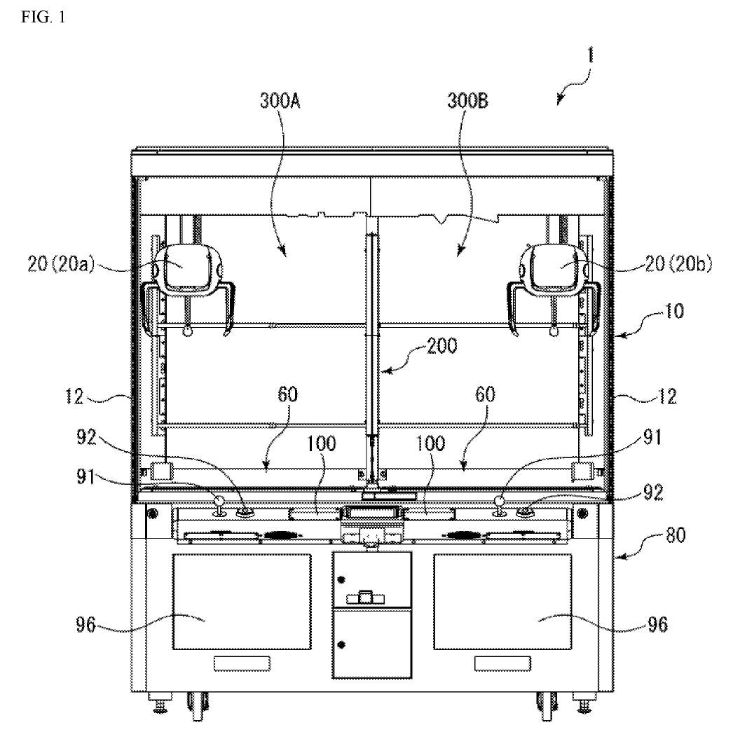

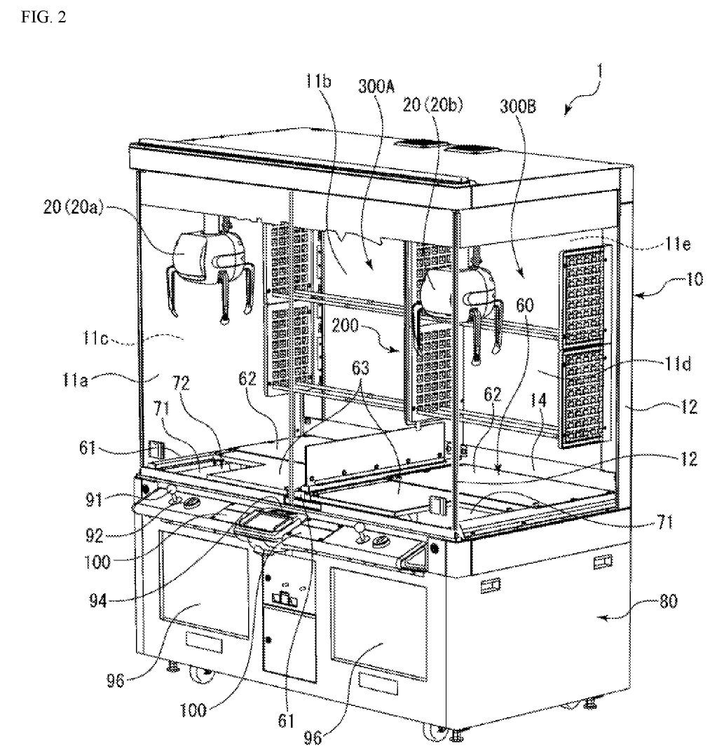

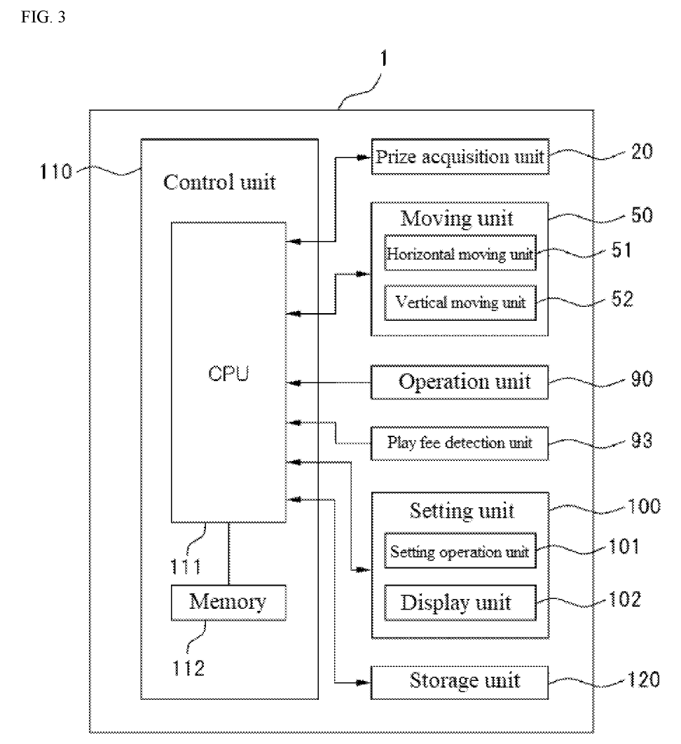

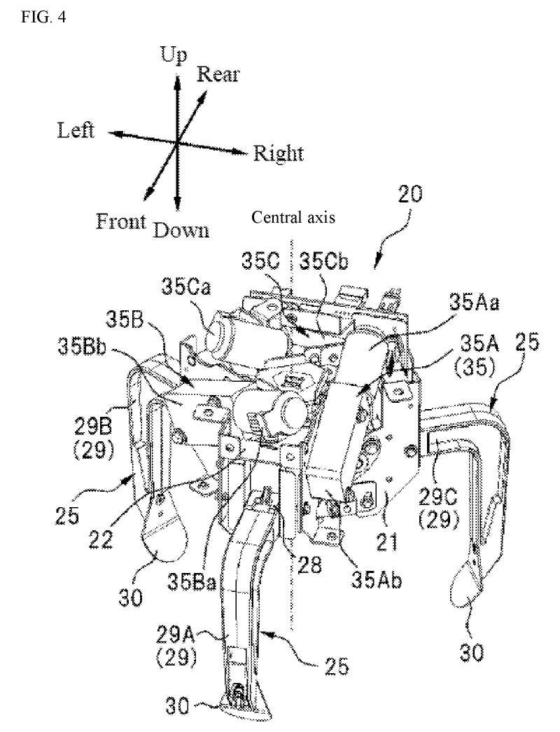

Configuration examples of a prize acquisition game device 1 according to one or more embodiments will be described with reference to FIGS. 1-4. FIG. 1 is an external view illustrating a configuration of the prize acquisition game device 1 according to one or more embodiments. FIG. 2 is a schematic perspective view illustrating a configuration of the prize acquisition game device 1 according to one or more embodiments. FIG. 3 is a block diagram illustrating a configuration of the prize acquisition game device 1 according to one or more embodiments. FIG. 4 is a schematic view illustrating a configuration of a prize acquisition unit (or prize catcher) 20 according to one or more embodiments. FIG. 4 illustrates a state where a design cover of the prize acquisition unit 20 has been removed.

In the following description, each direction is defined as illustrated in each figure. That is, the vertical direction is defined as the "up-down direction," and "up" and "down" are defined depending on gravity. In addition, the front-rear direction is defined as the “front” being the front side and the “rear” being the rear side from the perspective of a player playing the game facing the prize acquisition game device 1. Additionally, the direction perpendicular to the up-down and front-rear directions is defined as the "left-right direction," and "right" and "left" are defined based on the view from the player's side.

The prize acquisition game device 1 according to one or more embodiments is used when a player plays a prize acquisition game, and includes an accommodation portion 10 that accommodates one or more prizes, and a base 80 provided below the accommodation portion 10.

As illustrated in FIGS. 1-2, the accommodation portion 10 is formed of transparent members 11a to 11e (for example, transparent resin, glass, or the like) on the front and rear surfaces and the left and right side surfaces thereof such that the prize accommodated in the accommodation space can be recognized by the player. The left and right transparent members 11a to 11b constituting the front surface of the accommodation portion 10 are slidably provided in the left-right direction, and by opening either one of the left or right transparent members 11a or 11b, a service provider (for example, a store clerk) can arrange or replenish prizes. Pillar portions 12 extending in the up-down direction are disposed at four corners of the accommodation portion 10.

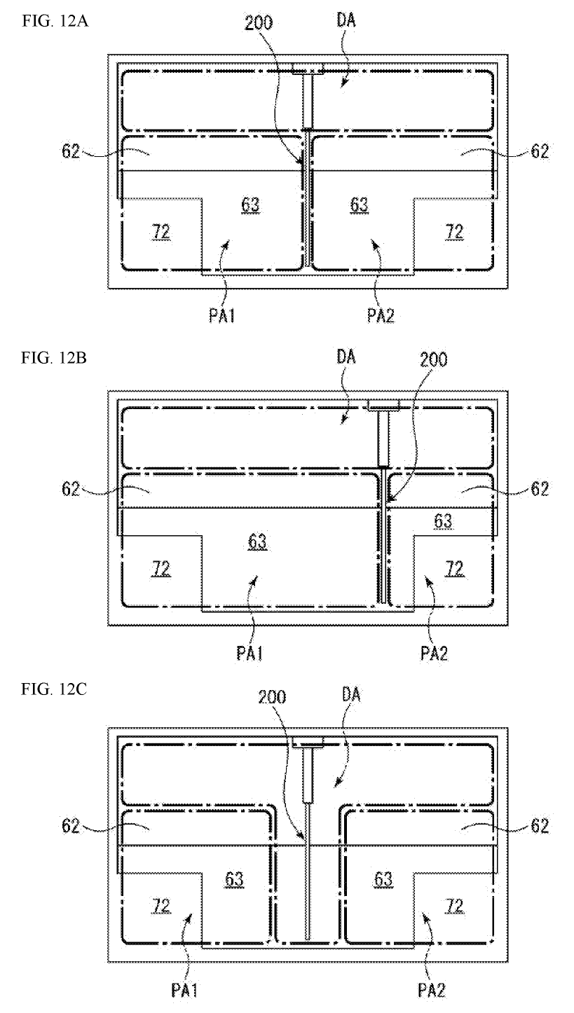

In front of the accommodation space surrounded by the accommodation portion 10, a play area composed of a first play area PA1 and a second play area PA2 for the player to play the prize acquisition game is provided, and a non-play area DA is disposed at the rear of the accommodation space (see FIGS. 12A-12C). In a case where the pillar portions 12 on both sides of the transparent members 11a and 11b are formed of a mirror-like member or a transparent member, they will not stand out visually, thereby making the play area appear wider.

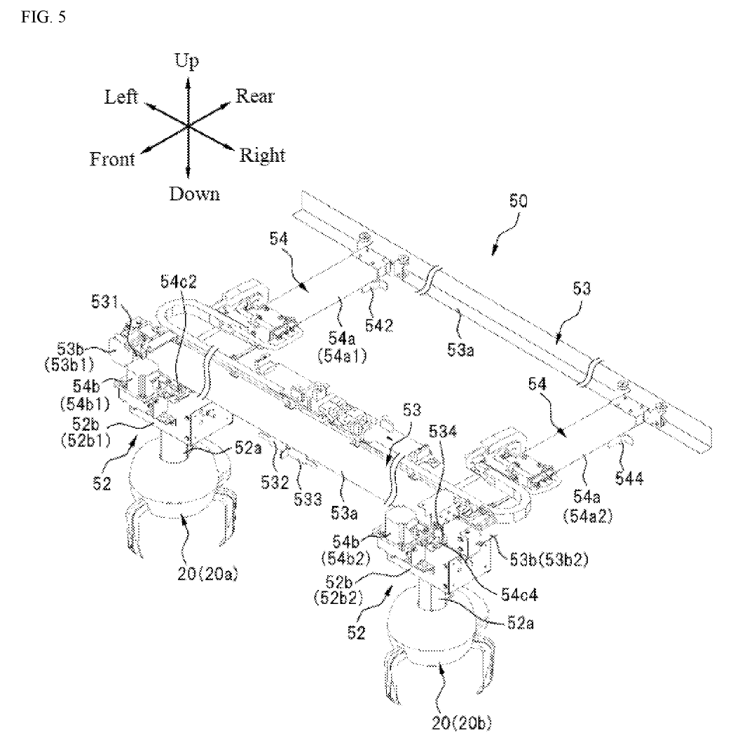

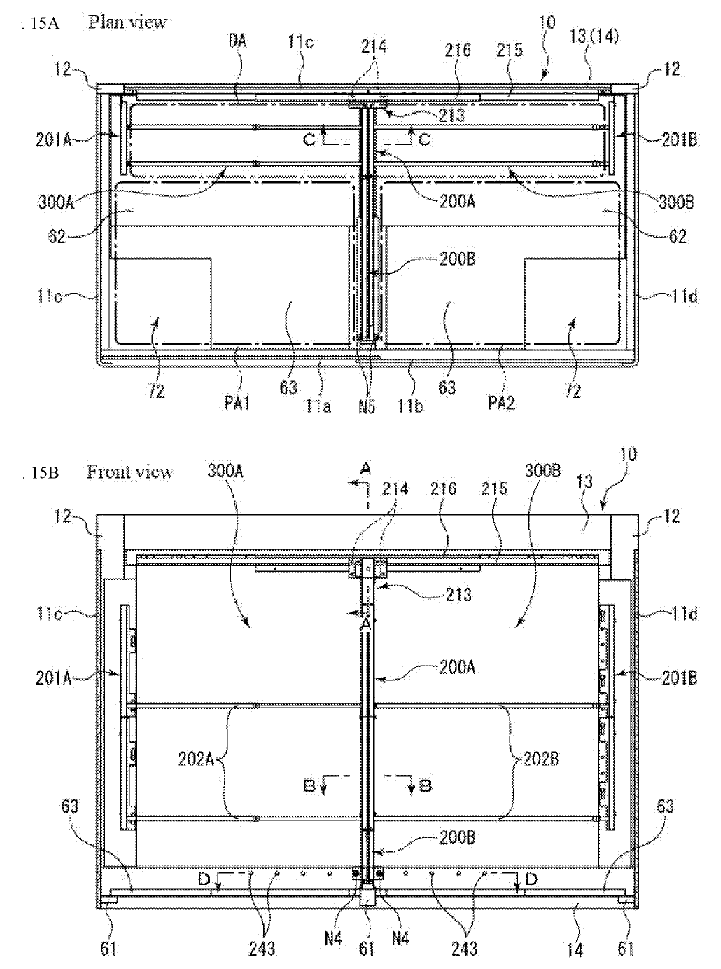

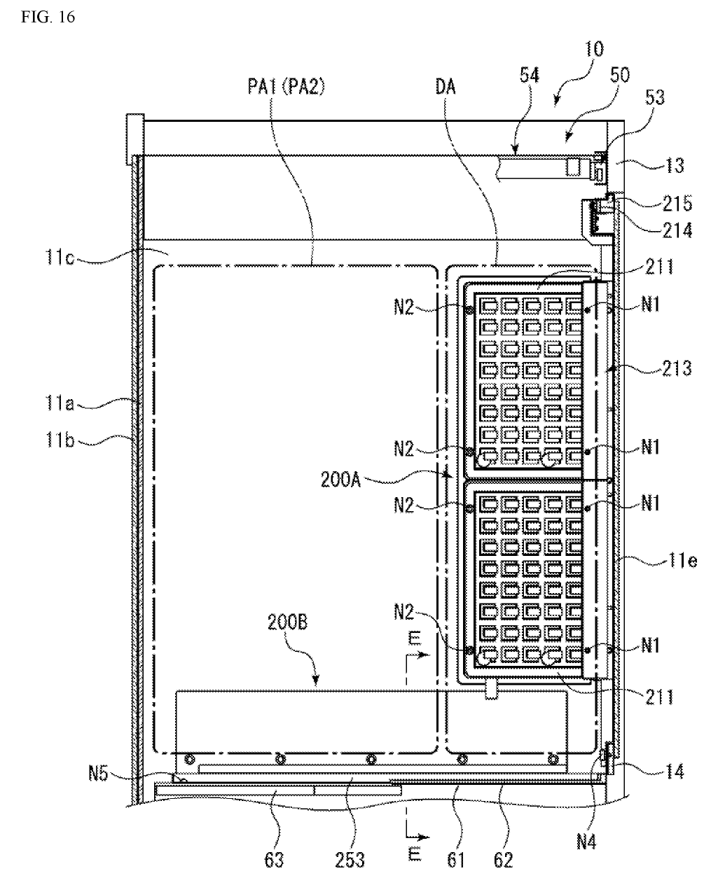

As illustrated in FIGS. 1-2, the accommodation portion 10 according to one or more embodiments has the prize acquisition unit 20 that performs an operation of acquiring the prize in the accommodation space, a moving unit 50 (see FIG. 5) that moves the prize acquisition unit 20 in the accommodation space, a placement portion 60 for placing prizes in the accommodation space, and a partition body 200 that partitions the accommodation space in the left-right direction. The moving unit 50 is disposed on the upper part of the accommodation portion 10 (see FIG. 16).

According to one or more embodiments, the first play area PA1 is formed on the left side of the accommodation space, and the second play area PA2 is formed on the right side of the accommodation space (see FIGS. 12A-12C). The prize acquisition unit 20 and the placement portion 60 are disposed corresponding to the first play area PA1 on the left side and the second play area PA2 on the right side, respectively. Therefore, within the first play area PA1 and the second play area PA2, each prize acquisition unit 20 is configured to move so that prizes placed on each placement portion 60 can be acquired.

In addition, prize exhibit units 300A and 300B are provided on the left and right sides of the non-play area DA at the rear of the first play area PA1 and the second play area PA2, in which prizes, decorations, or the like placed in the first play area PA1 and the second play area PA2 can be displayed. The prize exhibit units 300A and 300B will be described in detail later.

As illustrated in FIG. 1, the prize acquisition unit 20 according to one or more embodiments has a first prize acquisition unit (or first prize catcher) 20a corresponding to the first play area PA1 on the left side, and a second prize acquisition unit (or second prize catcher) 20b corresponding to the second play area PA2 on the right side. A movable range of the first prize acquisition unit 20a within the accommodation space is limited to within the first play area PA1, and a movable range of the second prize acquisition unit 20b within the accommodation space is limited to within the second play area PA2.

The prize acquisition unit 20 is for acquiring the prizes accommodated in the accommodation portion 10 (the prizes placed in the placement portion 60) by an opening/closing operation of an arm. As illustrated in FIG. 1, the prize acquisition unit 20 according to one or more embodiments is configured such that the prize can be grasped by means of three arms, and is connected to a lower end of a raising/lowering portion 52a (see FIG. 5).

As illustrated in FIG. 4, the prize acquisition unit 20 according to one or more embodiments has a base portion 21 connected to the lower end of the raising/lowering portion 52a, a plurality of arm portions 25 that perform the opening/closing operation, and a driving unit (or driver) 35 that drives the arm portions 25 to open and close.

The base portion 21 has trifurcated protruding portions 22 that are offset in three directions at 120 degree intervals from a central axis along the vertical direction.

The arm portion 25 has an arm 29 bent into an L shape or a semicircle shape, an arm linking portion 28 that detachably connects the arm 29 to the base portion 21, and a claw 30 that is detachably attached to a tip of the arm 29.

The arm 29 is composed of three arms, a first arm 29A, a second arm 29B, and a third arm 29C, which extend in a trifurcated shape shifted at 120 degree intervals in three directions around the central axis of the base portion 21 so as to match the trifurcated shape of the protruding portion 22.

The driving unit 35 is composed of three units, a first driving unit (or first driver) 35A, a second driving unit (or second driver) 35B, and a third driving unit (or third driver) 35C, which are provided for each arm. As illustrated in FIG. 4, the first driving unit 35A, the second driving unit 35B, and the third driving unit 35C correspond to the first arm 29A, the second arm 29B, and the third arm 29C, respectively, and drive the same to open and close separately.

The first driving unit 35A has an arm opening/closing motor 35Aa, and a gearbox 35Ab connected to the arm opening/closing motor 35Aa. The gearbox 35Ab reduces the rotational force of the arm opening/closing motor 35Aa and outputs the rotational force.

Similarly, the second driving unit 35B has an arm opening/closing motor 35Ba, and a gearbox 35Bb connected to the arm opening/closing motor 35Ba, and the third driving unit 35C has an arm opening/closing motor 35Ca, and a gearbox 35Cb connected to the arm opening/closing motor 35Ca.

In the prize acquisition unit 20 according to one or more embodiments, for example, in a case where the first arm 29A is in an open state, when the arm opening/closing motor 35Aa rotates an output shaft in a predetermined direction, power is transmitted to the first arm 29A via the gearbox 35Ab, and the first arm 29A rotates in a closing direction. At this time, the second arm 29B and the third arm 29C also rotate in the closing direction in the same manner by the driving of the arm opening/closing motor 35Ba and the arm opening/closing motor 35Ca, respectively.

As illustrated in FIG. 1, the moving unit 50 is disposed at an upper part inside the accommodation portion 10, and moves the prize acquisition unit 20 within the play area formed by the accommodation portion 10. As illustrated in FIG. 3, the moving unit 50 according to one or more embodiments has a horizontal moving unit 51 and a vertical moving unit 52.

The horizontal moving unit 51 moves the prize acquisition unit 20 in the horizontal direction (that is, the front-rear direction and the left-right direction) in the play area. The vertical moving unit 52 moves the prize acquisition unit 20 in the vertical direction (that is, the up-down direction) in the play area.

The placement portion 60 is for placing, in the accommodation portion 10, the prizes that can be acquired by the prize acquisition unit 20. As illustrated in FIG. 2, the placement portion 60 according to one or more embodiments has a support portion 61, a first prize placement portion 62 that forms an opening region 71 while being disposed in the accommodation space, and a second prize placement portion 63 that forms a drop port region 72 for dropping the prize by closing a part of the opening region 71 while being disposed in the accommodation space.

The support portion 61 supports the first prize placement portion 62 and the second prize placement portion 63 such that they can be disposed in the accommodation space. According to one or more embodiments, the first prize placement portion 62 is fixedly supported such that redisposition is not possible within the accommodation space, and the second prize placement portion 63 is supported such that redisposition is possible within the accommodation space.

The support portion 61 according to one or more embodiments supports the second prize placement portion 63 below the first prize placement portion 62 in a slidable state. Therefore, by sliding the second prize placement portion 63 in the front-rear direction, the second prize placement portion 63 can be redisposed with respect to the first prize placement portion 62, and the shape or size of a placement region where the prize can be placed can be changed, or the shape or size of the drop port region 72 can be changed.

The first prize placement portion 62 is fixed within the accommodation space, and its position cannot be changed in principle. As illustrated in FIG. 2, in the accommodation space, a region in which the first prize placement portion (or fixed prize placement portion) is not provided (unblocked region) is defined as the opening region 71.

The second prize placement portion 63 is configured to be redisposed within the accommodation space, and as illustrated in FIG. 2, is supported by the support portion 61 so as to block a part of the opening region 71, thereby forming the drop port region 72.

When the prize that is dropped after being acquired by the prize acquisition unit 20 passes (falls) through the drop port region 72 of the placement portion 60, it is considered to have moved from the play area to the base 80. The prize that is dropped from the drop port region 72 of the placement portion 60 is detected by an optical sensor, and then guided to a prize outlet 96 via a guide path. The optical sensor detects the presence or absence of the prize by using a light-emitting portion and a light-receiving portion that are installed on the guide path.

The base 80 is a base portion of a housing provided below the accommodation portion 10, and holds the accommodation portion 10 at a high position such that a player can play a game while facing the front in a standing position.

As illustrated in FIGS. 1-3, the base 80 according to one or more embodiments has an operation unit (or operation device) 90, a play fee detection unit (or play fee detector) 93, the prize outlet 96, a setting unit (or setting device) 100, a control unit (or control device) 110, and a storage unit (or storage) 120.

The operation unit 90 is for performing a game operation by the player. As illustrated in FIGS. 1-3, the operation unit 90 according to one or more embodiments has at least a joystick 91 and an operation button 92.

The joystick 91 is an operating lever that is used by the player to move the prize acquisition unit 20 in the horizontal direction. The operation button 92 is an operation button that is used by the player to determine the position of the prize acquisition unit 20 in the horizontal direction. When the operation button 92 is pressed by the player, the prize acquisition unit 20 starts to be lowered at the determined position. It should be noted that, instead of using the joystick 91, an operation button similar to the operation button 92 may be used, and while the operation button is being pressed, movement in a lateral direction within the horizontal direction may be performed, and in this case, the operation button 92 may be configured to allow movement in the depth direction within the horizontal direction, and when the operation of the operation button 92 is terminated, the prize acquisition unit 20 may start to be lowered at the position.

The play fee detection unit 93 is for detecting payment of a play fee by the player. The play fee detection unit 93 according to one or more embodiments has a coin slot 94, a coin detection sensor (not illustrated), a coin passage path (not illustrated), and a coin box (not illustrated).

According to one or more embodiments, a prize acquisition game is started when the player inserts a predetermined number of coins into a coin slot 94. A coin inserted through the coin slot 94 is detected by the coin detection sensor.

The coin detection sensor is, for example, an optical sensor, and detects the presence or absence of the coin inserted through the coin slot 94 by the light-emitting portion and the light-receiving portion provided on the coin passage path. Coins that have passed through the coin passage path in this manner are stored in the coin box.

The prize outlet 96 is provided on the front surface of the base 80 and is for taking out the prize that has fallen when the prize acquired by the prize acquisition unit 20 falls through the drop port region 72 in the placement portion 60.

The setting unit 100 is provided for use when the player performs the game operation or the like, or when a service provider performs a setting operation. As illustrated in FIGS. 1-3, the setting unit 100 according to one or more embodiments has a setting operation unit (or setting operation device) 101 and a display unit (or display device) 102.

The setting operation unit 101 is for receiving an operation input. The setting operation unit 101 according to one or more embodiments is configured by a touch panel, and receives input instructions from an operator from a pressed position thereof.

The touch panel is stacked on the display unit 102, and when a touch operation is performed on a screen, the pressed position (or contact position) can be detected based on the change in electrostatic capacitance between a fingertip and a conductive film.

The display unit 102 displays various screens such as a game screen and a setting screen. The display unit 102 according to one or more embodiments includes a liquid crystal display.

The control unit 110 is provided inside the base 80 and is a control unit for carrying out various controls of the prize acquisition game device 1. As illustrated in FIG. 3, the control unit 110 includes at least a central processing unit (CPU) 111 and a memory 112.

The CPU 111 is an arithmetic processing device for controlling the entire game device. The memory 112 is used to secure a region for storing programs for the CPU 111, a working region, or the like, and has a storage element such as a RAM.

The storage unit 120 is a unit that stores programs or data for the control unit 110 to execute game processing. According to one or more embodiments, the storage unit 120 has a memory element such as a ROM, which is a read-only memory region.

### [Configuration of Moving Unit 50]

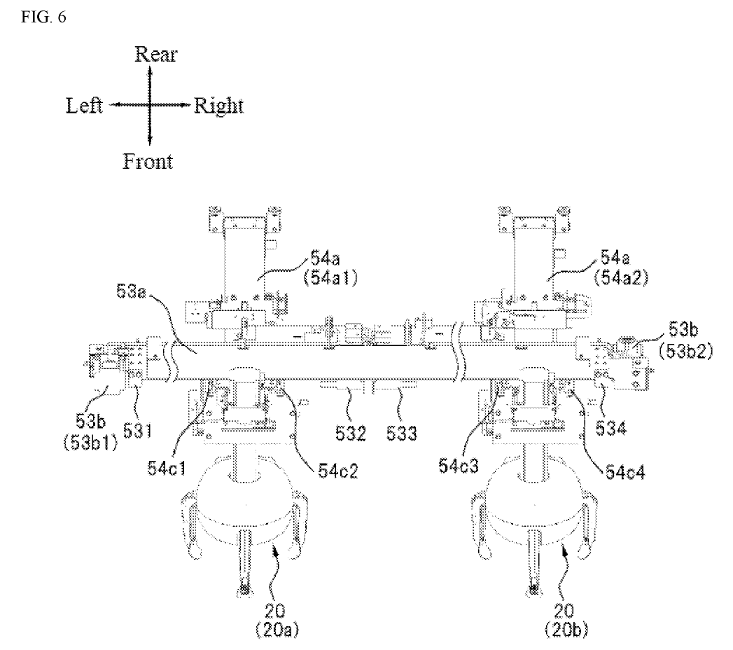

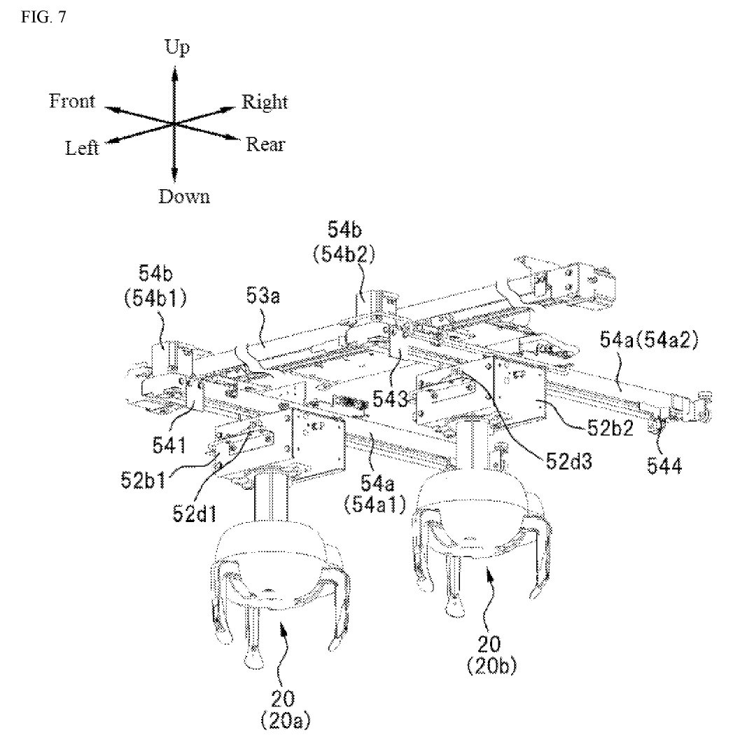

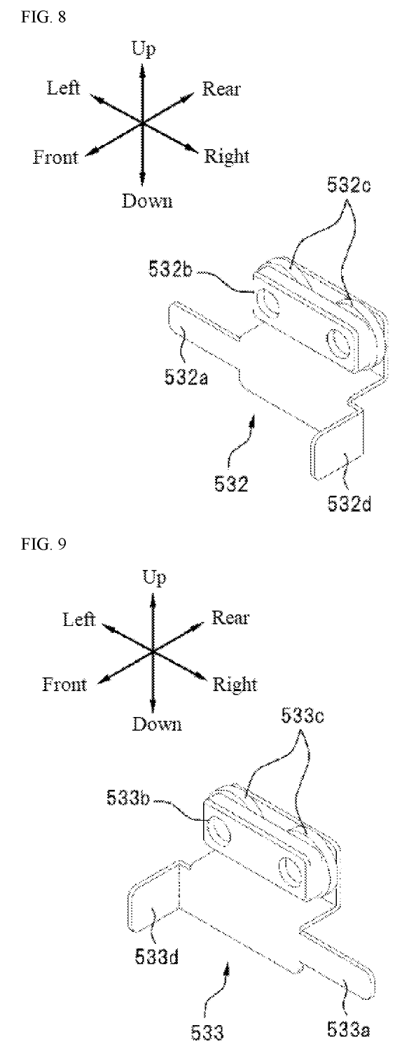

Configuration examples of the moving unit 50 according to one or more embodiments will be described with reference to FIGS. 5-9. FIG. 5 is a schematic perspective view illustrating a configuration of the moving unit 50 according to one or more embodiments. FIG. 6 is a top-surface side perspective view illustrating a configuration of the moving unit 50 according to one or more embodiments. FIG. 7 is a right-surface side perspective view illustrating a configuration of the moving unit 50 according to one or more embodiments. FIG. 8 is a schematic perspective view illustrating a configuration of a first right end actuating unit (or first right end actuator) 532 according to one or more embodiments. FIG. 9 is a schematic perspective view illustrating a configuration of a second left end actuating unit (or second left end actuator) 533 according to one or more embodiments.

Hereinafter, configurations of the horizontal moving unit 51 and the vertical moving unit 52 of the moving unit 50 according to one or more embodiments will be described in detail.

As illustrated in FIG. 5, the horizontal moving unit 51 has a left-right moving unit 53 and a front-rear moving unit 54. The left-right moving unit 53 moves the prize acquisition unit 20 in the left-right direction on the play area. The front-rear moving unit 54 moves the prize acquisition unit 20 in the front-rear direction on the play area.

As illustrated in FIG. 5, the left-right moving unit 53 according to one or more embodiments has a pair of fixed rails 53a extending in the left-right direction within the accommodation space, and left-right moving motors 53b that are disposed on both the left and right ends of the front-side fixed rails 53a.

As illustrated in FIG. 5, the front-rear moving unit 54 according to one or more embodiments has a plurality of moving rails 54a extending in the front-rear direction within the accommodation space, and a front-rear moving motor 54b disposed at a front end of each moving rail 54a.

As illustrated in FIG. 5, the vertical moving unit 52 has a raising/lowering portion (or lifter) 52a configured to be extendable and retractable along the up-down direction, and a suspending portion (or suspender) 52b that suspends the raising/lowering portion 52a so as to be freely raised and lowered. The raising/lowering portion 52a is configured by fitting a plurality of pipes of successively smaller diameters in a telescopic manner so as to be freely slidable. The prize acquisition unit 20 is attached to a lower end of the raising/lowering portion 52a in a state where it is connected to a wire that passes through the inside of the pipe. The raising/lowering portion 52a is attached to a lower end of the suspending portion 52b in a state where the prize acquisition unit 20 is suspended therefrom. An upper end of the suspending portion 52b is supported so as to be freely movable along the front-rear direction by the moving rail 54a.

The vertical moving unit 52 according to one or more embodiments, in an inner portion of the suspending portion 52b, has a wire winding portion, an up-down moving motor, an upper limit sensor, and a lower limit sensor. The wire winding portion is driven by the up-down moving motor to wind up the wire, thereby raising the prize acquisition unit 20 while sequentially storing the lower pipes in the upper pipe, or to unwind the wire, thereby lowering the prize acquisition unit 20 while sequentially sending out the lower pipes from the upper pipe. The upper limit sensor detects whether or not the raising of the prize acquisition unit 20 has stopped by winding up the wire connected to the prize acquisition unit 20. The lower limit sensor detects whether the lowering of the prize acquisition unit 20 has stopped based on the change in tension of the wire connected to the prize acquisition unit 20.

The fixed rail 53a according to one or more embodiments extends in the left-right direction across the first play area PA1 on the left side and the second play area PA2 on the right side, which are adjacent to each other on the left and right within the accommodation space, and as illustrated in FIG. 5, supports a first moving rail 54a1 corresponding to the first play area PA1 on the left side and a second moving rail 54a2 corresponding to the second play area PA2 on the right side, respectively, so as to be freely movable along a shared rail.

As illustrated in FIG. 5, a first left-right moving motor 53b1 for moving the first moving rail 54a1 in the left-right direction is disposed at a left end of the front-side fixed rail 53a. Furthermore, a second left-right moving motor 53b2 for moving the second moving rail 54a2 in the left-right direction is disposed at a right end of the front-side fixed rail 53a.

The front-side fixed rail 53a has a U-shaped cross-section, and is disposed inside thereof with a first driving pulley that is rotated by the first left-right moving motor 53b1, a first driven pulley that is attached to the right end of the front-side fixed rail 53a, and a first left-right belt that is hung between the first driving pulley and the first driven pulley.

Furthermore, the fixed rail 53a is disposed inside thereof with a second driving pulley that is rotated by the second left-right moving motor 53b2, a second driven pulley that is attached to the left end of the front-side fixed rail 53a, and a second left-right belt that is hung between the second driving pulley and the second driven pulley.

The first left-right belt and the second left-right belt are disposed to be parallel to each other inside the front-side fixed rail 53a, and the first moving rail 54a1 is connected to the first left-right belt via a first connection portion, and the second moving rail 54a2 is connected to the second left-right belt via a second connection portion.

Therefore, by rotating the first left-right movement motor 53b1 in a forward or reverse direction, the first moving rail 54a1 connected to the first left-right belt can move back and forth in the left-right direction along the fixed rail 53a. Similarly, by rotating the second left-right moving motor 53b2 in a forward or reverse direction, the second moving rail 54a2 connected to the second left-right belt can move back and forth in the left-right direction along the fixed rail 53a.

According to one or more embodiments, as illustrated in FIGS. 5 and 7, the first moving rail 54a1 supports a first suspending portion 52b1, from which a first prize acquisition unit 20a corresponding to the first play area PA1 on the left side is suspended, so as to be freely movable in the front-rear direction. That is, the first prize acquisition unit 20a is supported by the first moving rail 54a1 so as to be freely movable along the front-rear direction.

Similarly, a second suspending portion 52b2, from which the second prize acquisition unit 20b corresponding to the second play area PA2 on the right side is suspended, is supported by the second moving rail 54a2 so as to be freely movable in the front-rear direction. That is, the second prize acquisition unit 20b is supported by the second moving rail 54a2 so as to be freely movable along the front-rear direction.

In addition, as illustrated in FIGS. 5 and 7, a first front-rear moving motor 54b1 is disposed at a front end of the first moving rail 54a1 for moving, in the front-rear direction, the first suspending portion 52b1 from which the first prize acquisition unit 20a is suspended.

Similarly, a second front-rear moving motor 54b2 is disposed at a front end of the second moving rail 54a2 for moving the second suspending portion 52b2, from which the second prize acquisition unit 20b is suspended, in the front-rear direction.

The first moving rail 54a1 has a U-shaped cross-section, and is disposed inside thereof with a driving pulley that is rotated by the first front-rear moving motor 54b1, a driven pulley that is attached to a rear end of the first moving rail 54a1, and a front-rear belt that is hung between the driving pulley and the driven pulley. The first suspending portion 52b1 is connected to the front-rear belt via a connection portion.

Therefore, by rotating the first front-rear moving motor 54b1 in a forward or reverse direction, the first prize acquisition unit 20a, together with the first suspending portion 52b1 connected to the front-rear belt, can move back and forth in the front-rear direction along the first moving rail 54a1.

Similarly, the second moving rail 54a2 is disposed inside thereof with a driving pulley that is rotated by the second front-rear moving motor 54b2, a driven pulley that is disposed at a rear end of the second moving rail 54a2, and a front-rear belt that is hung between the driving pulley and the driven pulley. The second suspending portion 52b2 is connected to the front-rear belt via a connection portion.

Therefore, by rotating the second front-rear moving motor 54b2 in a forward or reverse direction, the second prize acquisition unit 20b, together with the second suspending portion 52b2 connected to the front-rear belt, can move back and forth in the front-rear direction along the second moving rail 54a2.

As illustrated in FIG. 6, a first left end sensor 54c1 that detects a left end position of the first play area PA1 is attached to a front left side of the first moving rail 54a1. As illustrated in FIG. 6, a first left end actuating unit (or first left end actuator) 531 that actuates the first left end sensor 54c1 is attached to a left end of the front-side fixed rail 53a.

As a result, when the first left end actuating unit 531 actuates the first left end sensor 54c1 due to leftward movement of the first moving rail 54a1, the first prize acquisition unit 20a, together with the first moving rail 54a1, is restricted from moving to the left side in the left-right direction within the first play area PA1.

As illustrated in FIG. 6, a first right end sensor 54c2 that detects a right end position of the first play area PA1 is attached to the front right side of the first moving rail 54a1. As illustrated in FIG. 6, the first right end actuating unit 532 that actuates the first right end sensor 54c2 is supported in the center of the front-side fixed rail 53a.

As a result, when the first right end actuating unit 532 actuates the first right end sensor 54c2 due to rightward movement of the first moving rail 54a1, the first prize acquisition unit 20a, together with the first moving rail 54a1, is restricted from moving to the right side in the left-right direction within the first play area PA1.

As illustrated in FIG. 6, a second left end sensor 54c3 that detects a left end position of the second play area PA2 is attached to the front left side of the second moving rail 54a2. As illustrated in FIG. 6, the second left end actuating unit 533 that actuates the second left end sensor 54c3 is supported in the center of the front-side fixed rail 53a.

As a result, when the second left end actuating unit 533 actuates the second left end sensor 54c3 due to leftward movement of the second moving rail 54a2, the second prize acquisition unit 20b, together with the second moving rail 54a2, is restricted from moving to the left side in the left-right direction within the second play area PA2.

As illustrated in FIG. 6, a second right end sensor 54c4 that detects a right end position of the second play area PA2 is attached to the front right side of the second moving rail 54a2. As illustrated in FIG. 6, a second right end actuating unit (or second right end actuator) 534 that actuates the second right end sensor 54c4 is attached to a right end of the front-side fixed rail 53a.

As a result, when the second right end actuating unit 534 actuates the second right end sensor 54c4 due to rightward movement of the second moving rail 54a2, the second prize acquisition unit 20b, together with the second moving rail 54a2, is restricted from moving to the right side in the left-right direction within the second play area PA2.

The first left end sensor 54c1, the first right end sensor 54c2, the second left end sensor 54c3, and the second right end sensor 54c4 are optical sensors that detect the presence or absence of a shielding object based on whether or not light irradiated from the light-emitting portion is received by the light-receiving portion. That is, each sensor can detect the presence or absence of a shielding object when each actuating unit comes between the light-emitting portion and the light-receiving portion.

The first left end actuating unit 531 and the second right end actuating unit 534 are fixed to the front-side fixed rail 53a such that their attachment positions cannot be changed in principle. In contrast, the first right end actuating unit 532 and the second left end actuating unit 533 are supported by the front-side fixed rail 53a so as to be freely movable in the left-right direction, so that their attachment positions can be changed (in other words, the right end position of the first play area PA1 and the left end position of the second play area PA2 can each be changed).

The first right end actuating unit 532 is an example of a first actuating unit (or first actuator), and is a member that is slidable relative to the front-side fixed rail 53a. As illustrated in FIG. 8, the first right end actuating unit 532 of one or more embodiments has a shielding unit (or shield) 532a that protrudes to the left side in the left-right direction to block light irradiated from the first right end sensor 54c2 (or first sensor), a magnet 532b, two wheels 532c, and a knob portion 532d that protrudes to the front in the front-rear direction.

According to one or more embodiments, a concave groove extending in the left-right direction is formed in the inner side surface of the front-side fixed rail 53a. The front-side fixed rail 53a supports the first right end actuating unit 532 such that the first right end actuating unit 532 can be guided by placing the wheels in the groove. A service provider (for example, a store clerk or the like) can operate the knob portion 532d to slide the first right end actuating unit 532 in the left-right direction along the front-side fixed rail 53a, thereby changing the position of the first right end actuating unit 532 and adjusting the right end position of the first play area PA1. The first right end actuating unit 532 can be fixed at a position after being slid by the magnet 532b (the position can be maintained after the first right end actuating unit 532 is slid).

The second left end actuating unit 533 is an example of a second actuating unit (or second actuator), and is a member that is slidable relative to the front-side fixed rail 53a. As illustrated in FIG. 9, the second left end actuating unit 533 of one or more embodiments has a shielding unit (or shield) 533a that protrudes to the right side in the left-right direction to block light irradiated from the second left end sensor 54c3 (or second sensor), a magnet 533b, two wheels 533c, and a knob portion 533d that protrudes to the front side in the front-rear direction.

According to one or more embodiments, similarly to the first right end actuating unit 532 described above, the second left end actuating unit 533 is guided by placing the wheels in the groove of the front-side fixed rail 53a. A service provider can adjust the left end position of the second play area PA2 by sliding the first right end actuating unit 532 in the left-right direction along the front-side fixed rail 53a and changing the position of the second left end actuating unit 533, by operating the knob portion 533d independently of the knob portion 532d of the first right end actuating unit 532. The second left end actuating unit 533 can be fixed at a position after being slid by the magnet 533b (the position can be maintained after the second left end actuating unit 533 is slid).

In this way, the front-side fixed rail 53a supports the first right end actuating unit 532 at a position after being slid between the first moving rail 54a1 and the second left end actuating unit 533, thereby making it possible to change the right end position of the first play area PA1, and supports the second left end actuating unit 533 at a position after being slid between the first right end actuating unit 532 and the second moving rail 54a2, thereby making it possible to change the left end position of the second play area PA2.

As illustrated in FIG. 7, a first front end sensor 52d1 that detects the front end position of the first play area PA1 is attached to a front end of the first suspending portion 52b1. As illustrated in FIG. 7, a first front end actuating unit (or first front end actuator) 541 that actuates the first front end sensor 52d1 is attached to the front end of the first moving rail 54a1.

As a result, when the first front end actuating unit 541 actuates the first front end sensor 52d1 due to forward movement of the first suspending portion 52b1, the first prize acquisition unit 20a, together with the first suspending portion 52b1, is restricted from moving to the front in the front-rear direction within in the first play area PA1.

As illustrated in FIG. 7, a second front end sensor 52d3 that detects the front end position of the second play area PA2 is attached to a front end of the second suspending portion 52b2. As illustrated in FIG. 7, a second front end actuating unit (or second front end actuator) 543 that actuates the second front end sensor 52d3 is attached to the front end of the second moving rail 54a2.

As a result, when the second front end actuating unit 543 actuates the second front end sensor 52d3 due to forward movement of the second suspending portion 52b2, the second prize acquisition unit 20b, together with the second suspending portion 52b2, is restricted from moving to the front in the front-rear direction within the second play area PA2.

A first rear end sensor (not illustrated) for detecting a rear end position of the first play area PA1 is attached to a rear end of the first suspending portion 52b1. As illustrated in FIG. 5, a first rear end actuating unit (or first rear end actuator) 542 that actuates the first rear end sensor is attached to the rear end of the first moving rail 54a1.

As a result, when the first rear end actuating unit 542 actuates the first rear end sensor due to rearward movement of the first suspending portion 52b1, the first prize acquisition unit 20a, together with the first suspending portion 52b1, is restricted from moving to the rear side in front-rear direction within the first play area PA1.

A second rear end sensor (not illustrated) for detecting a rear end position of the second play area PA2 is attached to the rear end of the second suspending portion 52b2. As illustrated in FIG. 5 and FIG. 7, a second rear end actuating unit (or second rear end actuator) 544 that actuates the second rear end sensor is attached to the rear end of the second moving rail 54a2.

As a result, when the second rear end actuating unit 544 actuates the second rear end sensor due to rearward movement of the second suspending portion 52b2, the second prize acquisition unit 20b, together with the second suspending portion 52b2, is restricted from moving to the rear side in the front-rear direction within the second play area PA2.

The first front end sensor 52d1, the first rear end sensor, the second front end sensor 52d3, and the second rear end sensor are optical sensors that detect the presence or absence of a shielding object based on whether or not light irradiated from the light-emitting portion is received by the light-receiving portion. That is, each sensor can detect the presence or absence of a shielding object when each actuating unit comes between the light-emitting portion and the light-receiving portion.

The first front end actuating unit 541 and the first rear end actuating unit 542 are fixed to the first moving rail 54a1 such that their attachment positions cannot be changed in principle. Similarly, the second front end actuating unit 543 and the second rear end actuating unit 544 are fixed to the second moving rail 54a2 such that their attachment positions cannot be changed in principle.

### [Settings of Play Areas]

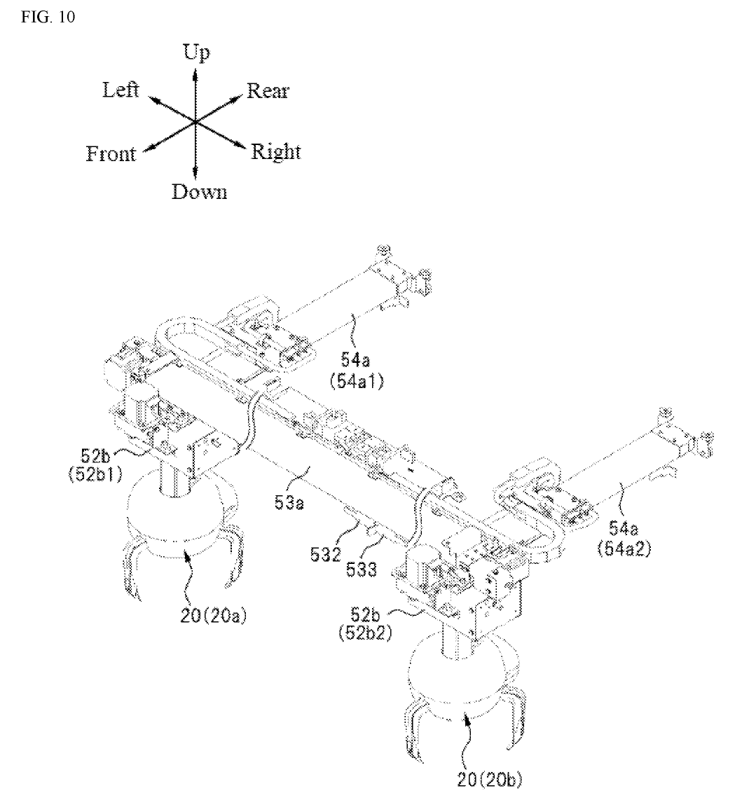

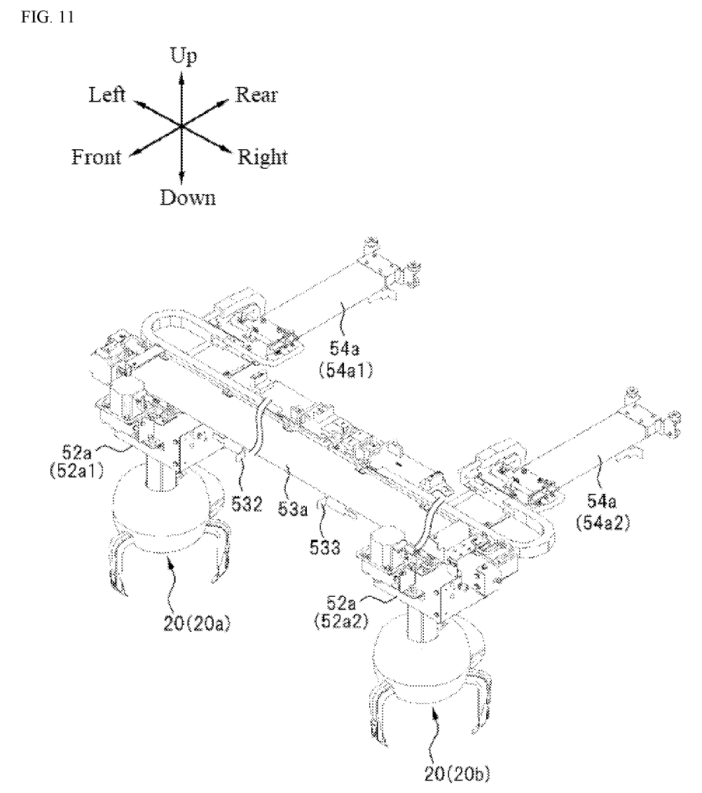

Settings of play areas according to one or more embodiments will be described with reference to FIGS. 10-12. FIG. 10 is a view illustrating a state where the first right end actuating unit 532 and the second left end actuating unit 533 have been moved to the right side. FIG. 11 is a view illustrating a state where the first right end actuating unit 532 has been moved to the left side and the second left end actuating unit 533 has been moved to the right side. FIGS. 12A-12C are views explaining the settings of the play areas. FIG. 12A is a view illustrating a state where the first play area PA1 and the second play area PA2 are set to the same size. FIG. 12B is a view illustrating a state where the second play area PA2 is set to be smaller than the first play area PA1. FIG. 12C is a view illustrating a state where the non-play area DA is set between the first play area PA1 and the second play area PA2. In the figure, each area is illustrated using a two-dot chain line.

As illustrated in FIG. 5, when the first right end actuating unit 532 and the second left end actuating unit 533 are moved to the center in the left-right direction of the fixed rail 53a by the operation of a service provider (for example, a store clerk or the like), the right end position of the first play area PA1 and the left end position of the second play area PA2 are set to the center in the left-right direction of the fixed rail 53a. In this case, as illustrated in FIG. 12A, the first play area PA1 and the second play area PA2 (regions enclosed by a one-dot chain line in the figure) have the same size. Therefore, movable ranges of the first prize acquisition unit 20a and the second prize acquisition unit 20b within the accommodation space also have the same size.

Furthermore, when the first right end actuating unit 532 and the second left end actuating unit 533 are slid rightward from the center in the left-right direction of the fixed rail 53a by the operation of a service provider, the right end position of the first play area PA1 and the left end position of the second play area PA2 are changed to positions slid rightward from the center in the left-right direction of the fixed rail 53a, as illustrated in FIG. 10. In this case, as illustrated in FIG. 12B, the first play area PA1 is larger than the second play area PA2. Therefore, compared to the state illustrated in FIG. 5, the movable range of the first prize acquisition unit 20a within the accommodation space is expanded, while the movable range of the second prize acquisition unit 20b within the accommodation space is reduced. As will be described later, the partition body 200 can be moved in the left-right direction according to changes in the size of the first play area PA1 and the second play area PA2.

Furthermore, as illustrated in FIG. 11, when, by the operation of a service provider, the first right end actuating unit 532 is slid leftward from the center in the left-right direction of the fixed rail 53a, and the second left end actuating unit 533 is slid rightward from the center in the left-right direction of the fixed rail 53a, the right end position of the first play area PA1 is changed to a position slid leftward from the center in the left-right direction of the fixed rail 53a, and the left end position of the second play area PA2 is changed to a position slid rightward from the center in the left-right direction of the fixed rail 53a. In this case, the fixed rail 53a supports the first right end actuating unit 532 and the second left end actuating unit 533 such that there is an interval between the right end position of the first play area PA1 and the left end position of the second play area PA2, and thus, as illustrated in FIG. 12C, the non-play area DA is formed between the first play area PA1 and the second play area PA2. Therefore, compared to the state illustrated in FIG. 5, although the movable ranges of the first prize acquisition unit 20a and the second prize acquisition unit 20b within the accommodation space are respectively reduced, it becomes possible to place display prizes, decorative items, or the like not only in the rear non-play area DA but also in the front non-play area DA, and to install a display (or small monitor) or the like used for advertisement, game explanation, and the like.

### [Operation of Prize Acquisition Game Device 1]

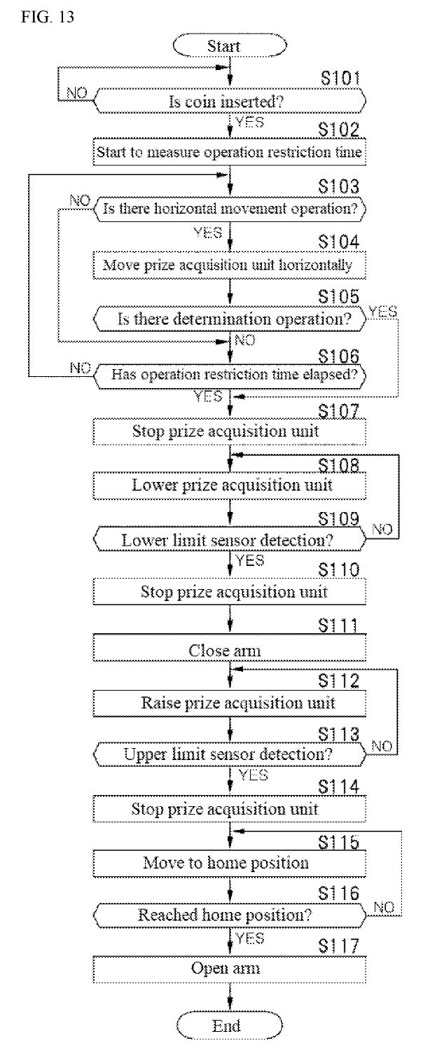

The operation of the prize acquisition game device 1 according to one or more embodiments will be described with reference to FIG. 13. FIG. 13 is a flowchart explaining operation examples of the prize acquisition game device 1 according to one or more embodiments. Hereinafter, an example of operation in the first play area PA1 will be specifically explained, and an explanation of the second play area PA2 will be omitted as it is similar to the first play area PA1.

When the play fee detection unit 93 detects the insertion of a coin (step S101: YES), the control unit 110 starts to measure a preset operation restriction time (step S102).

Next, when an operation signal for horizontally moving the first prize acquisition unit 20a is received by the player operating the joystick 91 (step S103: YES), the control unit 110 drives the horizontal moving unit 51 in accordance with the operation of the player to move the first prize acquisition unit 20a horizontally in the first play area PA1 (step S104).

According to one or more embodiments, when the first prize acquisition unit 20a is moving horizontally in the first play area PA1, in a case where the first right end actuating unit 532 actuates the first right end sensor 54c2 due to rightward movement of the first moving rail 54a1, the control unit 110 stops the first prize acquisition unit 20a at the right end position of the first play area PA1. In addition, when the first rear end actuating unit 542 actuates the first rear end sensor due to rearward movement of the first suspending portion 52b1, the first prize acquisition unit 20a is stopped at the rear end position of the first play area PA1. In addition, when the first left end actuating unit 531 actuates the first left end sensor 54c1 by moving the first moving rail 54a1 leftward, the first prize acquisition unit 20a is stopped at the left end position of the first play area PA1. In addition, when the first front end actuating unit 541 actuates the first front end sensor 52d1 due to forward movement of the first suspending portion 52b1, the first prize acquisition unit 20a is stopped at the front end position of the first play area PA1.

On the other hand, when the player does not operate the joystick 91 (step S102: NO), the control unit 110 determines whether or not the operation restriction time has elapsed (step S106). When the operation restriction time has not elapsed (step S106: NO), the process returns to step S103. When the operation time limit has elapsed (step S106: YES), the first prize acquisition unit 20a is stopped (step S107).

Next, when an operation signal for determining the position of the first prize acquisition unit 20a after horizontal movement by the player operating the operation button 92 is received (step S105: YES), the control unit 110 stops the first prize acquisition unit 20a at the position after the horizontal movement (step S107).

On the other hand, when the player does not operate the operation button 92 (step S103: NO), the control unit 110 determines whether or not the operation restriction time has elapsed (step S106). When the operation restriction time has not elapsed (step S106: NO), the process returns to step S103. When the operation restriction time has elapsed (step S106: YES), the first prize acquisition unit 20a is stopped (step S107).

Next, when the first prize acquisition unit 20a stops (step S107), the control unit 110 drives the vertical moving unit 52 to lower the first prize acquisition unit 20a to the stopping position in the first play area PA1 (step S108).

When the lower limit sensor detects that the lowering of the first prize acquisition unit 20a has stopped (step S109: YES), the control unit 110 stops the first prize acquisition unit 20a (step S110).

Next, when the first prize acquisition unit 20a is in a stopped state (step S110), the control unit 110 causes the driving unit 35 to rotate the arm portion 25 in a closing direction (step S111).

Next, when the arm portion 25 of the first prize acquisition unit 20a is in a closed state (step S111), the control unit 110 drives the vertical moving unit 52 to raise the first prize acquisition unit 20a (step S112).

When it is detected that the first prize acquisition unit 20a has stopped raising by the upper limit sensor (step S113: YES), the control unit 110 stops the first prize acquisition unit 20a (step S114).

Next, the control unit 110 drives the horizontal moving unit 51 to move the first prize acquisition unit 20a toward a home position (step S115), and determines whether or not the first prize acquisition unit 20a has reached the home position (step S116).

According to one or more embodiments, when the first left end actuating unit 531 actuates the first left end sensor 54c1 due to leftward movement of the first moving rail 54a1, and the first front end actuating unit 541 actuates the first front end sensor 52d1 due to forward movement of the first suspending portion 52b1, it is determined that the first prize acquisition unit 20a has reached the home position.

Next, when the first prize acquisition unit 20a is located at the home position (step S116: YES), the control unit 110 causes the driving unit 35 to rotate the arm portion 25 in an opening direction (step S117).

As described above, according to the prize acquisition game device 1, a service provider can individually change the size of the first play area PA1 and the second play area PA2 by adjusting the positions of the first right end actuating unit 532 (or first actuating unit) and the second left end actuating unit 533 (or second actuating unit) in the left-right direction along the fixed rail 53a. In each of the first play area PA1 and the second play area PA2 whose size has been changed, it is possible to limit the movable range within the accommodation space of each of the first prize acquisition unit 20a and the second prize acquisition unit 20b.

### [Details of the Prize Exhibit Unit]

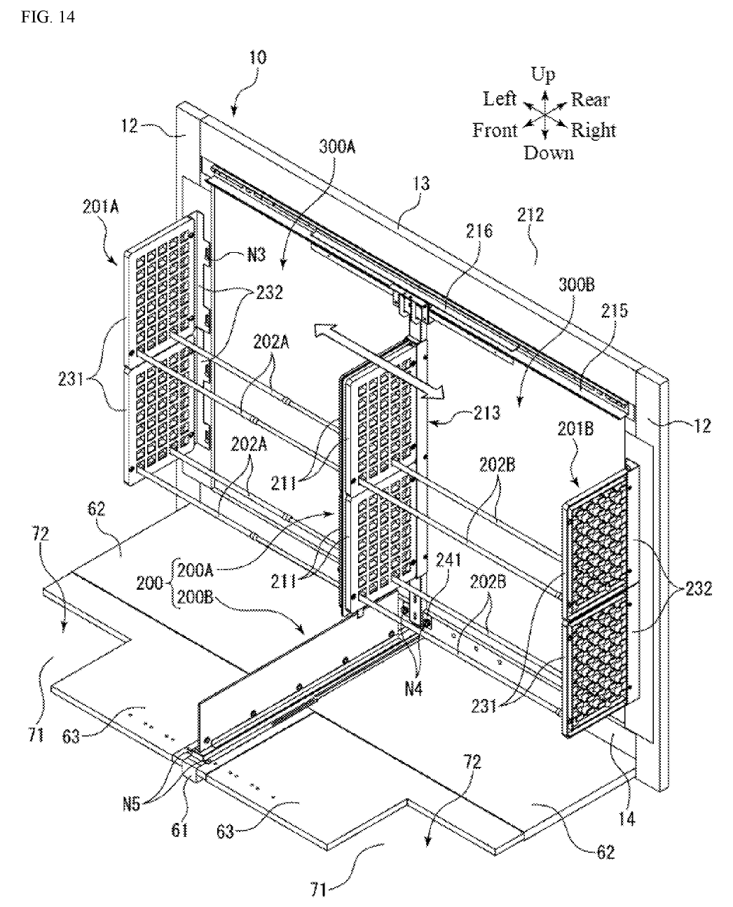

Next, the prize exhibit units 300A and 300B will be described in detail with reference to FIGS. 14-23C.

As illustrated in FIGS. 14-16, the prize exhibit units 300A and 300B mainly includes a first partition 200A, which is a part of the partition body 200, side holding bodies 201A and 201B disposed at left and right rear sides of the accommodation space, a plurality (for example, four) of rod-shaped members 202A extending between the first partition 200A and the left-side holding body 201A, and a plurality (for example, four) of rod-shaped members 202B extending between the first partition 200A and the right-side holding body 201B, and prizes can be displayed by placing the prizes on a pair of rod-shaped members 202A and 202A or 202B and 202B arranged in the front-rear direction, by interposing the prizes therebetween, or by interposing the prizes between the rear rod-shaped members 202A or 202B and the transparent member 11e.

The first partition 200A and the left and right holding bodies 201A and 201B are formed in the shape of vertically elongated rectangular plates having front-rear dimensions approximately the same as those of the non-play area DA, and are provided approximately perpendicular to the rear transparent member 11e.

### [Partition Body]

As illustrated in FIGS. 14-16, the partition body 200 mainly includes a first partition 200A extending in the up-down direction so as to partition the prize exhibit units 300A and 300B in the left-right direction, and a second partition 200B extending in the front-rear direction so as to partition the play area into the first play area PA1 and the second play area PA2 in the left-right direction.

The first partition 200A mainly includes vertically elongated rectangular holding plates 211 and 211 disposed at left and right sides thereof, a vertically elongated rectangular intermediate plate 212 disposed between the left and right holding plates 211 and 211, and a metal moving frame 213 which extends in the up-down direction and to which the holding plates 211 and 211 and a rear end of the intermediate plate 212 are attached. The intermediate plate 212 is formed slightly larger than the holding plates 211 and 211, and upper, lower, and front end portions thereof protrude outward from the holding plates 211 and 211 in a state where the intermediate plate 212 is interposed between the holding plates 211 and 211.

The holding plates 211 and 211 and intermediate plate 212 are formed of a light-transmitting synthetic resin plate so as to be inconspicuous, thereby allowing the prize exhibit units 300A and 300B to appear larger. In addition, the left and right holding plates 211 and 211 are arranged vertically, so that a total of four holding plates 211 are arranged on the left and right sides. These four holding plates 211 are all identical in size and structure. Although the first partition 200A includes the left and right holding plates 211 and 211 and the intermediate plate 212, the intermediate plate 212 may be omitted or the first partition 200A may include a single holding plate.

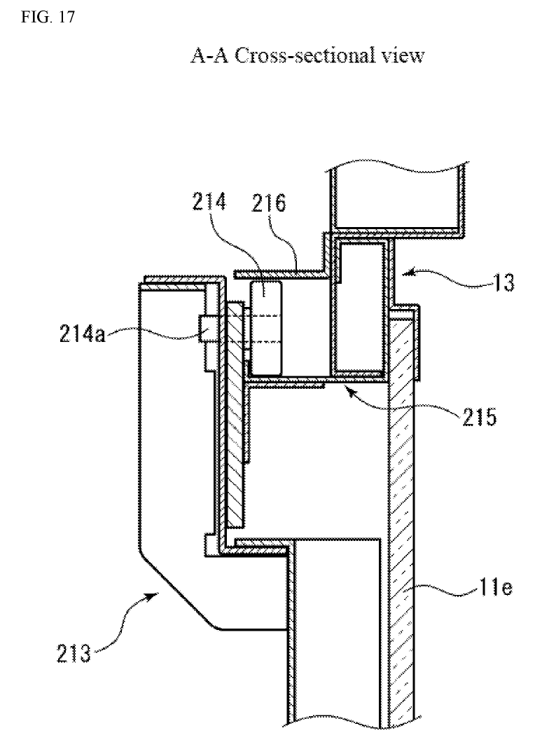

As illustrated in FIG. 17, a pair of left and right guide rollers 214 and 214 (see FIGS. 15A-15B) is provided on the upper part of the moving frame 213 so as to be rotatable about a rotation shaft 214a facing in the front-rear direction. A metal guide rail 215 extending in the left-right direction is fixed to a front surface of an upper horizontal frame material 13 that connects upper end portions of pillar portions 12 and 12 disposed at left and right rear sides of the accommodation portion 10, and guide rollers 214 and 214 are provided on the guide rail 215 so as to be rollable in the left-right direction. In this way, the moving frame 213 is suspended so as to be movable in the left-right direction from the guide rails 215 via the guide rollers 214 and 214. Note that, the upper part of the guide rail 215 is open (see FIG. 14), but a restriction rail 216 having a predetermined length is fixed to the upper part near the center in the left-right direction, thereby restricting the guide rollers 214 and 214 from falling out.

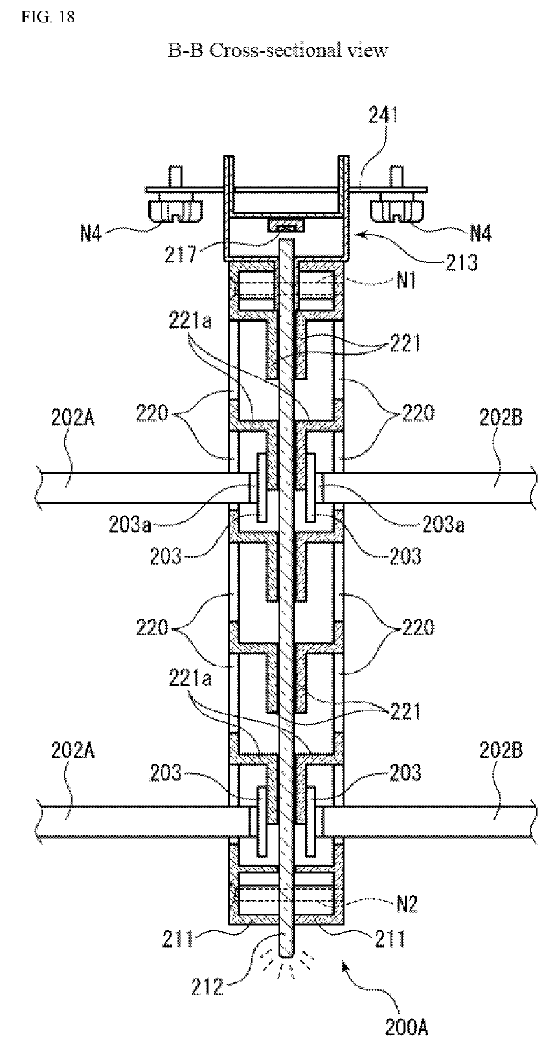

As illustrated in FIG. 18, the holding plates 211 and 211 and the rear end of the intermediate plate 212 are attached to the front side of the moving frame 213 by screw members N1. In addition, the holding plates 211 and 211 and a front side of the intermediate plate 212 are integrated by screw members N2 that pass therethrough in the left-right direction. Inside the moving frame 213, a plurality of light-emitting diodes (LEDs) 217, which is arranged at predetermined intervals in the up-down direction, is provided such that light can be incident on a rear end surface of the intermediate plate 212, and when the light-emitting diodes 217 emit light, a front end surface and upper and lower end surfaces of the intermediate plate 212 emit surface light.

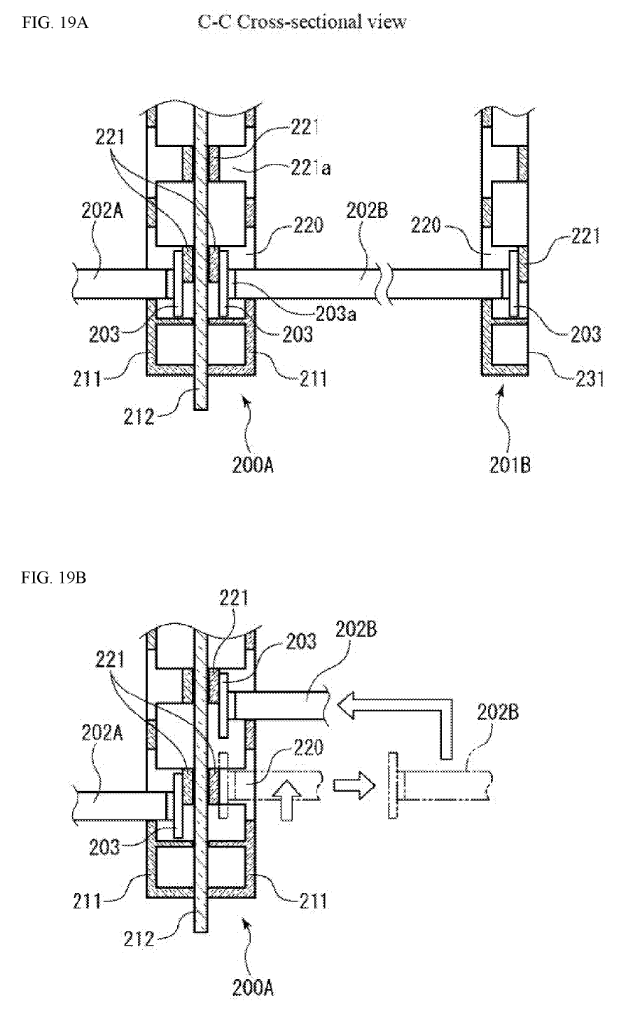

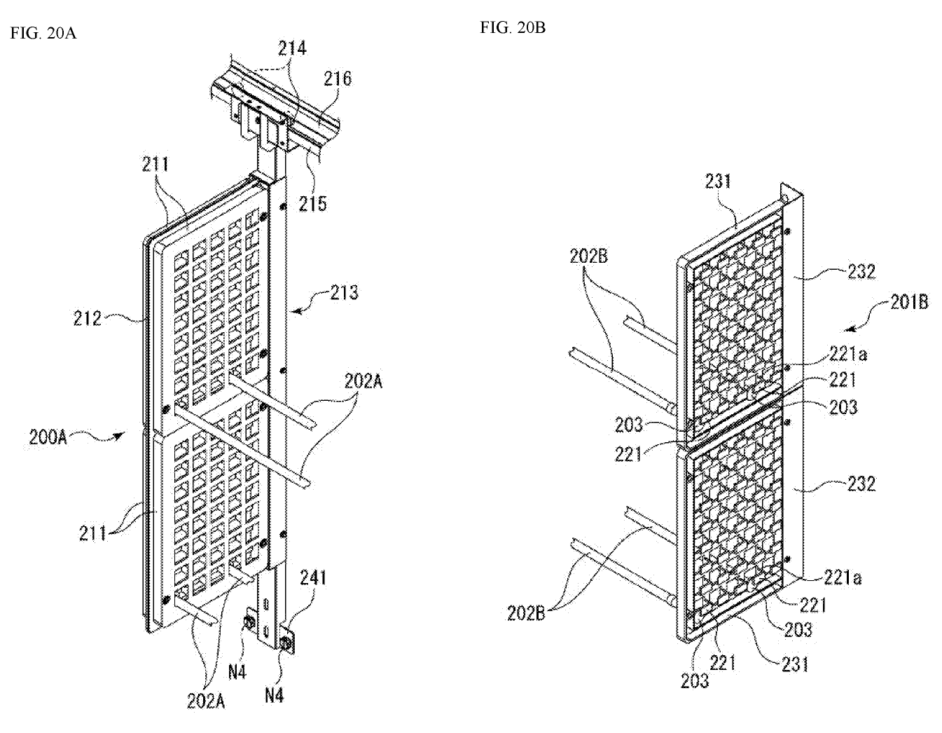

As illustrated in FIGS. 19A-19B and 20A-20B, each holding plate 211 has a plurality of rectangular through-holes 220 formed therein. According to one or more embodiments, eight through-holes 220 arranged in the up-down direction are formed in five rows in the front-rear direction, and a total of forty through-holes 220 are formed. A restriction piece 221 facing the front-rear direction is formed by bending at a tip of a connection piece 221a extending in the left-right direction from a front edge or rear edge of each through-hole 220. The restriction piece 221 is disposed at a position spaced apart from the through-hole 220 by a predetermined gap in the left-right direction, and, when end portions of the rod-shaped members 202A and 202B inserted into the through-hole 220 abut thereagainst, the end portions are prevented from protruding (projecting) toward a deeper side in an insertion direction from the through-hole 220. The left and right holding plates 211 and 211 are disposed such that the respective restriction pieces 221 and 221 face each other with the central intermediate plate 212 interposed therebetween.

Each of the rod-shaped members 202A and 202B includes a large-diameter circular tube and a small-diameter circular tube slidably inserted into the large-diameter circular tube, and the overall length thereof can be extended and retracted by changing an insertion length of the small-diameter circular tube. Caps 203a each having a large-diameter flange portion 203 formed at an end portion thereof are attached to both ends of the rod-shaped members 202A and 202B, and, by inserting the flange portions 203 into the through-holes 220 and placing the flange portions 203 on lower edges of the through-holes 220, the rod-shaped members 202A and 202B are held at predetermined height positions. In addition, the flange portions 203 are locked in the lower edges of the through-holes 220, thereby preventing the end portions of the rod-shaped members 202A and 202B from escaping from the through-holes 220, and the flange portions 203 abut against the restriction piece 221, thereby restricting the flange portions 203 from protruding toward the deeper side in the insertion direction from the through-holes 220. Although the rod-shaped members 202A and 202B do not have a fixing mechanism that prevents the large-diameter circular tube and the small-diameter circular tube from extending or retracting, or a tensioning mechanism that biases the large-diameter circular tube and the small-diameter circular tube in the extension direction, they may have the fixing mechanism or the tensioning mechanism.

In this way, since the plurality of through-holes 220 is formed in the holding plate 211, as illustrated in FIG. 19B, the holding positions of the rod-shaped members 202A and 202B can be changed in the front-rear and up-down directions by lifting upward the rod-shaped member 202B having one end inserted into the through-hole 220, releasing locking between the flange portion 203 and the lower edge of the through-hole 220, pulling out the rod-shaped member 202B, and inserting the pulled-out one end into another through-hole 220.

Further, when the end portions of the rod-shaped members 202A and 202B are inserted into and held in the plurality of through-holes 220 formed in the holding plates 211 of the side holding bodies 201A and 201B, the end portions of the rod-shaped members 202A and 202B may protrude toward the deeper side from the holding plates 211, thereby deteriorating the appearance. However, according to one or more embodiments, since the restriction pieces 221 are provided on the deeper sides of the through-holes 220, protrusion of the end portions of the rod-shaped members 202A and 202B is restricted, so that the appearance can be improved.

As illustrated in FIG. 14, the side holding bodies 201A and 201B, which are disposed on the left and right sides of the accommodation space, each include holding plates 231 and 231 each arranged vertically, and brackets 232 and 232 attached to front surfaces of the pillar portions 12 and 12 by a plurality of screw members N3 and holding rear portions of the upper and lower holding plates 231. The upper and lower holding plates 231 and 231 of each side holding body 201A or 201B are all identical in size and structure to the holding plate 211 of the first partition 200A, so that detailed descriptions thereof will be omitted by assigning the same reference numerals to similar configurations or parts.

Further, the upper and lower holding plates 231, 231 of each side holding body 201A or 201B are disposed with the restriction pieces 221 facing the left and right transparent members 11c and 11d, and are disposed at a predetermined gap from the left and right transparent members 11c and 11d (see FIGS. 15A-15B).

According to one or more embodiments, the plurality of through-holes 220 into which the rod-shaped members 202A and 202B serving as prize support bodies can be inserted are formed in the holding plates 211 and 231, but the number, size, shape, and the like of the through-holes 220 are arbitrary and can be variously modified. In addition, the holding plates 211 and 231 do not necessarily need to have through-holes or restriction pieces 221 formed therein, as long as they have holding portions including recesses or protrusions that can hold the end portion of the prize support body. Furthermore, instead of providing such a holding portion in the holding body, a tensioning mechanism or the like may be provided in the prize support body so that the prize support body is held between the left and right holding bodies by a biasing force in the extending direction.

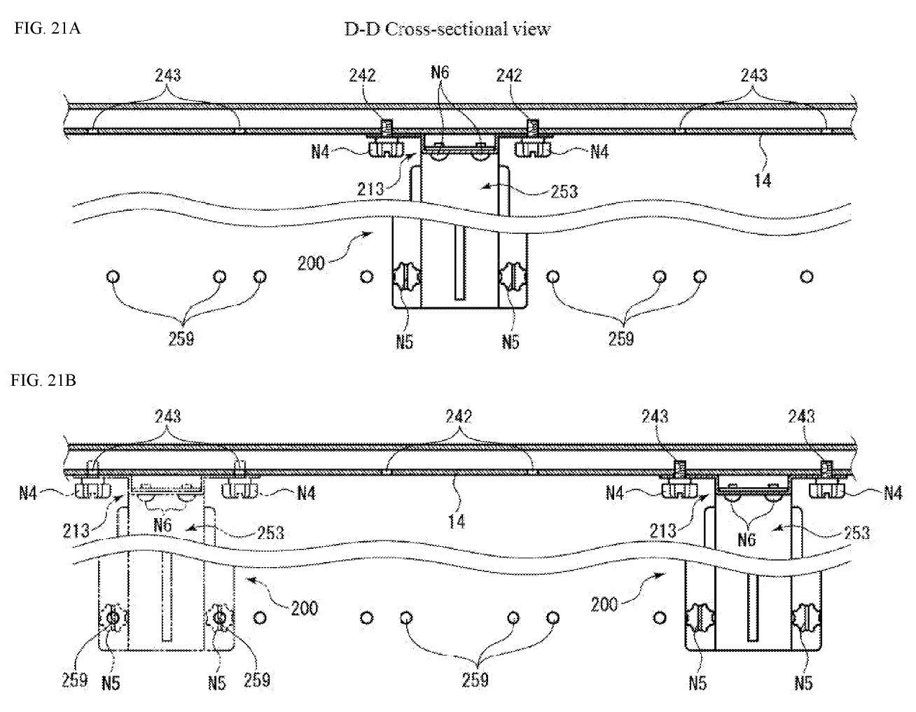

As illustrated in FIG. 20A, an attachment plate 241 protruding in the left-right direction is fixed to the lower part of the moving frame 213, and attachment holes 242 and 242 (see FIG. 21A) are formed in the left and right sides of the attachment plate 241, and thumbscrews N4 and N4 are attached to the attachment holes 242 and 242. On the other hand, on a front surface of a lower horizontal frame material 14 that connects lower end portions of pillar portions 12 and 12 disposed at the left and right rear sides of the accommodation portion 10, a plurality of screw holes 243 is formed at predetermined intervals in the left-right direction, as illustrated in FIG. 21A. Therefore, the lower part of the moving frame 213 can be fixed in position to the lower horizontal frame material 14 by the thumbscrews N4 and N4, which are attached to the attachment holes 242 and 242, being screwed into a pair of left and right screw holes 243 and 243. In addition, as illustrated in FIG. 21B, the lower part of the moving frame 213 can be fixed at any position in the left-right direction by selectively screwing the same into any pair of left and right screw holes 243 and 243.

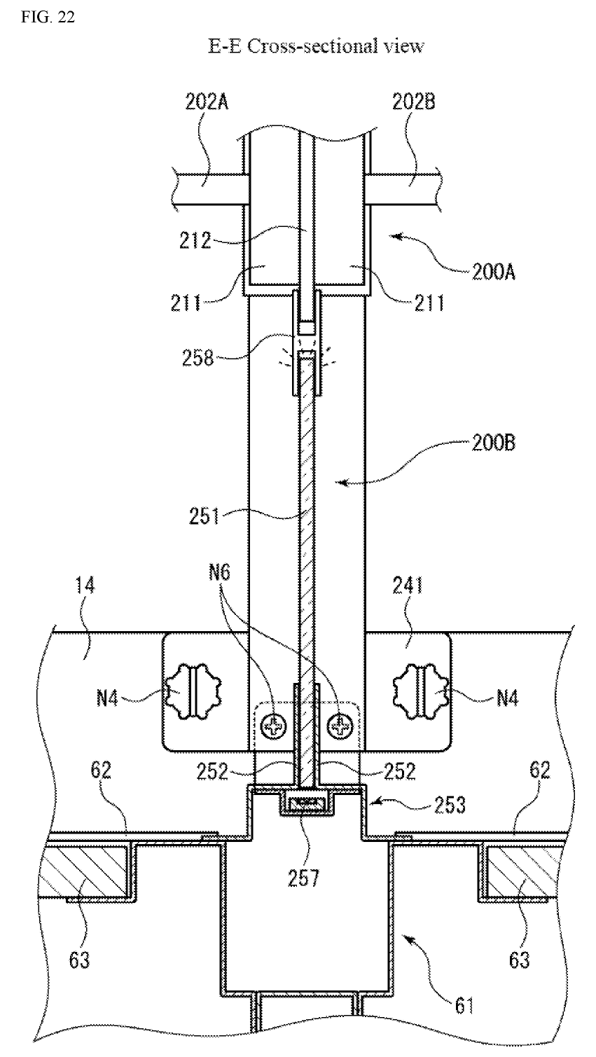

As illustrated in FIG. 22, the second partition 200B mainly includes a partition plate 251 formed of a light-transmitting synthetic resin plate having a horizontally elongated rectangular shape, and a metal moving frame 253 extending in the front-rear direction. The partition plate 251 is erected substantially perpendicular to the placement portion 60, and a lower end thereof is attached to the moving frame 253 via an attachment bracket 252. Inside the moving frame 253, a plurality of light-emitting diodes (LEDs) 257, which is arranged at predetermined intervals in the front-rear direction, is provided such that light can be incident on a lower end surface of the partition plate 251, and when the light-emitting diodes 257 emit light, front and rear end surfaces and an upper end surface of the partition plate 251 emit surface light.

As illustrated in FIG. 21B, the moving frame 253 can be fixed at any position in the left-right direction by left and right thumbscrews N5 and N5 attached to the front position being screwed into a plurality of screw holes 259 and 259 formed at predetermined intervals in the left-right direction in the second prize placement portion 63. The locations where the screw holes 259 and 259 are formed are not limited to the second prize placement portion 63, and the screw holes 259 and 259 may be formed at other locations, such as a support portion 61 (see FIG. 22) including a vertical frame material extending in the front-rear direction and disposed at the center position in the left-right direction at the lower part of the accommodation portion 10, or the first prize placement portion 62.

Further, the thumbscrew N4 at the lower part of the moving frame 213 and the thumbscrew N5 at the front portion of the moving frame 253 are configured to be able to select one of a plurality of fixed positions by screwing the thumbscrew into one of the plurality of screw holes 243 and 259 formed in the left-right direction, but instead of the plurality of screw holes 243 and 259, an elongated hole extending in the left-right direction may be formed so that the moving frames 213 and 253 can be fixed at any position in the left-right direction.

As illustrated in FIG. 22, the rear end of the moving frame 253 is fixed to the lower end of the moving frame 213 of the first partition 200A via screw members N6 and N6. In addition, a lower part of an H-shaped clip 258 formed of a light-transmitting synthetic resin plate is clamped at an upper end of the partition plate 251, and an upper part of the H-shaped clip 258 is clamped at the lower end of the intermediate plate 212 of the first partition 200A, so that the partition plate 251 and the intermediate plate 212 are connected to each other.

As illustrated in FIGS. 14-16, the partition body 200 is formed in a roughly L-shape when viewed from the left side, with the first partition 200A extending in the up-down direction and the second partition 200B extending in the front-rear direction, and partitions the accommodation space within the accommodation portion 10 in the left-right direction. In detail, the first partition 200A is disposed so as to partition the prize exhibit units 300A and 300B located in the non-play area DA at the rear side of the accommodation space into left and right sections, and the second partition 200B is disposed so as to partition the lower parts of the first play area PA1 and the second play area PA2 at the front side of the accommodation space into left and right sections. The vertical dimension of the second partition 200B can be changed as desired, and may have a vertical dimension that allows the area above the first play area PA1 and the second play area PA2 to be partitioned left and right.

### [Change of Fixed Position of Partition Body]

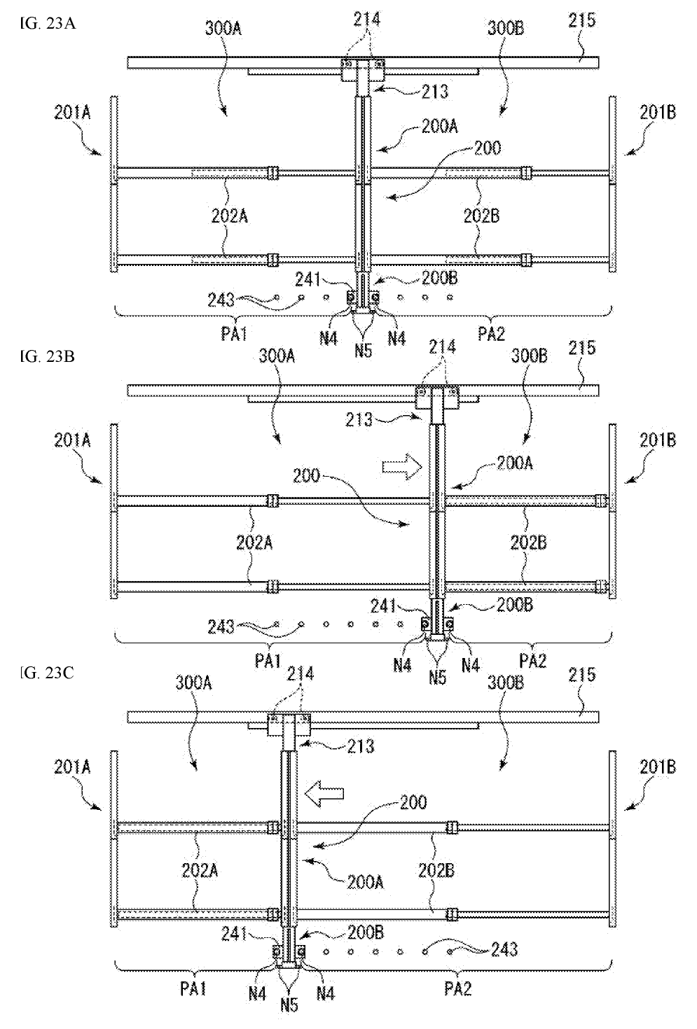

Next, a case where the fixed position of the partition body 200 is changed depending on the settings of the play areas will be described. First, as shown in FIG. 23A, when the first partition 200A and the second partition 200B are disposed at a substantially center position in the left-right direction of the accommodation space, the first partition 200A is disposed at a substantially center position between the left and right holding bodies 201A and 201B, so that the prize exhibit unit 300A having the size corresponding to the first play area PA1 is set at the rear side of the left-side first play area PA1, and the prize exhibit unit 300B having the size corresponding to the second play area PA2 is set at the rear side of the right-side second play area PA2. That is, the first play area PA1, the second play area PA2, and the prize exhibit units 300A and 300B are each set to approximately the same size.

Further, when a service provider (for example, a store clerk) sets the second play area PA2 to be smaller than the first play area PA1, as illustrated in FIG. 23B, the thumbscrews N4 and N4 attached to the attachment plate 241 at the lower part of the moving frame 213 are removed from the screw holes 243 and 243, and the thumbscrews N5 and N5 (see FIGS. 21A-21B) of the moving frame 253 are removed from the screw holes 259 and 259 (see FIGS. 21A-21B) of the second prize placement portion 63, and the partition body 200 is slid rightward. As the first partition 200A moves to the right, each rod-shaped member 202A on the left side extends, and each rod-shaped member 202B on the right side retracts.

After the moving frame 213 moves to a predetermined position, the thumbscrews N4 and N4 are screwed into the screw holes 243 and 243 on the right side, and the thumbscrews N5 and N5 are screwed into the screw holes 259 and 259 on the right side. As a result, the lower part of the partition body 200 is fixed to the lower horizontal frame material 14 and the second prize placement portion 63 so that movement in the left-right direction is restricted.

Further, when a service provider (for example, a store clerk) sets the first play area PA1 to be smaller than the second play area PA2, as illustrated in FIG. 23C, first, the thumbscrews N4 and N4 attached to the attachment plate 241 at the lower part of the moving frame 213 are removed from the screw holes 243 and 243, and the thumbscrews N5 and N5 of the moving frame 253 are removed from the screw holes 259 and 259 (see FIGS. 21A-21B), so that the partition body 200 is slid leftward. As the first partition 200A moves to the left, each rod-shaped member 202A on the left side retracts, and each rod-shaped member 202B on the right side extends.

After the moving frame 213 moves to a predetermined position, the thumbscrews N4 and N4 are screwed into the screw holes 243 and 243 on the left side, and the thumbscrews N5 and N5 are screwed into the screw holes 259 and 259 on the left side. As a result, the lower part of the partition body 200 is fixed to the lower horizontal frame material 14 and the second prize placement portion 63 so that movement in the left-right direction is restricted.

Further, in the rod-shaped members 202A and 202B, the flange portions 203 at both left and right ends are locked in opening peripheral edges of the through-holes 220 of the holding plates 211 and 231, and protrusion toward the deeper side in the insertion direction from the through-holes 220 is restricted by the restriction pieces 221, so that the rod-shaped members 202A and 202B are prevented from falling out of the holding plates 211 and 231 or from protruding outward from the side holding bodies 201A and 201B to come into contact with the transparent members 11c and 11d, and are extendable and retracted according to the movement of the first partition 200A in the left-right direction to be changed to an appropriate length. Before moving the partition body 200, a service provider (for example, a store clerk) may remove the rod-shaped members 202A and 202B from the holding plates 211 and 231 in advance, adjust lengths thereof by extending and retracting the same to appropriate lengths, and then reattach the same to the holding plates 211 and 231.

### [Actions and Technological Effects]

As described above, the prize acquisition game device 1 of one or more embodiments of the present invention allows a player to play a game to acquire a prize accommodated in an accommodation space, prize exhibit units 300A and 300B for displaying the prize is disposed at the rear inside the accommodation space, and a partition body 200 for partitioning the accommodation space in the left-right direction is provided so as to be movable in the left-right direction. Accordingly, by moving the partition body 200 for partitioning the accommodation space in the left-right direction, the left-right width of the first play area PA1 and the second play area PA2 or the left-right width of the prize exhibit units 300A and 300B can be freely changed depending on the type of the prize.

In addition, the accommodation space is composed of the prize exhibit units 300A and 300B provided in the non-play area DA at the rear side thereof, and the first play area PA1 and second play area PA2 on the front side thereof, and the partition body 200 partitions at least the prize exhibit units 300A and 300B in the left-right direction, so that the width of the prize exhibit units 300A and 300B can be changed depending on the type of the prize.

More specifically, the partition body 200 has a first partition 200A that partitions, into left and right sections, the prize exhibit unit 300A corresponding to the first play area PA1 and the prize exhibit unit 300B corresponding to the second play area PA2, so that prize exhibit units 300A and 300B having the sizes corresponding to the respective play areas can be easily set according to changes in the sizes of the first play area PA1 and the second play area PA2.

Further, the first partition 200A serves as a partition that partitions the non-play area DA into the prize exhibit units 300A and 300B on the left and right sides and a holding body that holds one end portion of the rod-shaped members 202A and 202B that serve as prize support bodies, so that the non-play area DA and the prize exhibit units can be efficiently partitioned using a common member.

Further, the partition body 200 is composed of the first partition 200A that extends in the up-down direction to partition the prize exhibit units 300A and 300B, and the second partition 200B that extends in the front-rear direction to partition the first play area PA1 and the second play area PA2, so as to be formed in a roughly L-shape when viewed from the left side, thereby increasing the strength of the partition body 200. In addition, since the second partition 200B is disposed at a low height so as to partition the lower part of the play area and does not partition the upper part of the play area, a decrease in visibility of the prize exhibit units 300A and 300B on the other side from one side of the first play area PA1 and the second play area PA2 is prevented.

Further, the first partition 200A of the partition body 200, which partitions the prize exhibit units 300A and 300B, is fixed in position by the lower horizontal frame material 14 at a rear lower part of the accommodation space, so that it is not necessary to perform processing such as forming screw holes in members located at the rear side of the accommodation space, for example, the transparent member 11e, in accordance with a position to which the partition body 200 has been moved, thereby improving the appearance of the rear side of the accommodation space.

In addition, the guide rail 215 extending in the left-right direction is provided on the upper horizontal frame material 13 at the rear upper part of the accommodation space, and the upper part of the partition body 200 is slidably suspended from the guide rail 215, so that the partition body 200 can be safely moved in the left-right direction with a small amount of force. In addition, the guide rail 215 is fixed below the left-right moving unit 53 of the strong upper horizontal frame material 13 that fixes the left-right moving unit 53 for moving the prize acquisition unit 20 in the left-right direction within the play area, so that the partition body 200 can be stably supported.

Further, the prize exhibit units 300A and 300B include rod-shaped members 202A and 202B serving as prize support bodies, one end portion of each of which is held by the first partition 200A, and the rod-shaped members 202A and 202B are configured as members having lengths that are adjustable in a left-right direction, so that the widths of the rod-shaped members 202A and 202B in the left-right direction can also be changed in accordance with changes in left-right widths of the prize exhibit units 300A and 300B due to movement of the partition body 200.

Further, the prize support body includes the rod-shaped members 202A and 202B that are extendable and retractable in the left-right direction, so that the left-right width of the prize support body can be changed with a simple structure.

Further, in the partition body 200, at least a part of end surfaces of the intermediate plate 212 and the partition plate 251 (for example, a front end surface and upper and lower end surfaces) emits surface light by irradiation light from the light-emitting diodes 217 and 257, so that, even when the partition body 200 is moved and the left-right widths of the play area and the prize exhibit units 300A and 300B are changed, boundaries between the play area and the non-play area DA can be clearly recognized without obstructing a field of view by the partition body 200.

Further, the rod-shaped members 202A and 202B serving as prize support bodies are installed between the partition body 200 and the side holding bodies 201A and 201B provided on the left and right sides of the accommodation space, so that the rod-shaped members 202A and 202B can be installed at different positions between the partition body 200 and the side holding bodies 201A and 201B.

Further, a plurality of through-holes 220 serving as a plurality of hole portions is formed in the partition body 200 and the side holding bodies 201A and 201B in the up-down and front-rear directions, and both ends of the rod-shaped members 202A and 202B are locked in the through-holes 220 of the partition body 200 and the side holding bodies 201A and 201B, so that the positions of the rod-shaped members 202A and 202B can be easily changed.

Further, the flange portions 203 are formed on both ends of the rod-shaped members 202A and 202B as locking portions that restrict the rod-shaped members 202A and 202B from falling out of the through-holes 220, so that it is possible to prevent rod-shaped members 202A and 202B from falling out.

Further, by providing the flange portion 203 as a movement restriction portion that restricts the rod-shaped members 202A and 202B serving as prize support bodies from moving outward of the partition body 200 or side holding bodies 201A and 201B, it is possible to prevent contact between the rod-shaped members 202A and 202B and adjacent members such as the transparent members 11c and 11d that form the accommodation space.

Although the embodiments of the present invention have been described above with reference to the drawings, the present invention is not limited to the embodiments, and it goes without saying that the present invention also includes modifications or additions that do not deviate from the spirit of the present invention.

### [Modified Example]

### [Partition Body]

In the above embodiments, a configuration has been exemplified in which the partition body 200 that partitions the accommodation space in the left-right direction is composed of the first partition 200A that partitions the non-play area DA in the left-right direction and the second partition 200B that partitions the first play area PA1 and the second play area PA2 in the left-right direction, but the present invention is not limited thereto, and any configuration capable of partitioning the accommodation space in the left-right direction may be employed. For example, the partition body may be composed of only the first partition 200A that partitions the non-play area DA in the left-right direction, or may include only the second partition 200B that partitions the first play area PA1 and the second play area PA2. Furthermore, the first partition 200A that partitions the non-play area DA into left and right sections partitions the prize exhibit units 300A and 300B into left and right sections, but as long as it partitions the non-play area DA into left and right sections, it does not necessarily have to be a partition that partitions the prize exhibit units 300A and 300B into left and right sections.

Further, in the above embodiments, a configuration has been exemplified in which both the left-right widths of the first play area PA1 and the second play area PA2 and the left-right widths of left and right accommodation spaces partitioned by the partition body 200 can be changed, but the present invention is not limited thereto, and a configuration may be employed in which either one of the left-right widths of the first play area PA1 and the second play area PA2 or the left-right widths of the left and right accommodation spaces partitioned by the partition body 200 can be changed. For example, in a configuration in which left-right widths of the first play area PA1 and the second play area PA2 are not changed, a configuration may be employed in which only the left-right widths of the prize exhibit units 300A and 300B are changed by moving the first partition 200A constituting the partition body 200 in the left-right direction.

Further, in the above embodiments, a configuration has been exemplified in which the first partition 200A and the second partition 200B constituting the partition body 200 are integrated and movably configured in the left-right direction, but the present invention is not limited thereto, and the first partition 200A and the second partition 200B may be provided separately and individually movable in the left-right direction.

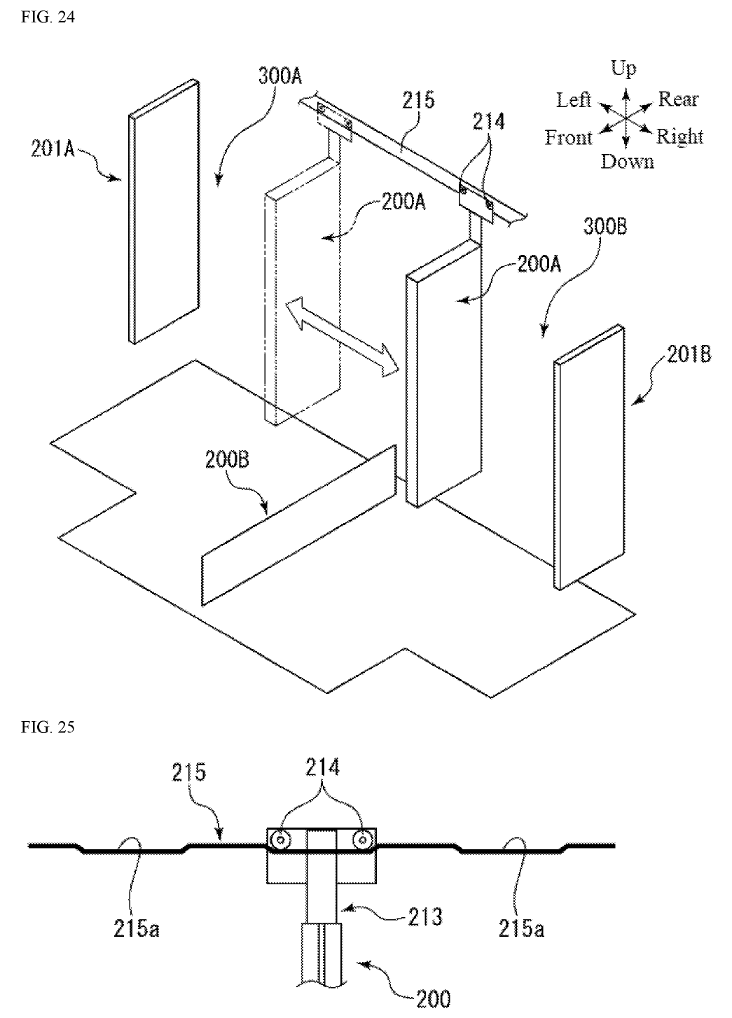

Further, as illustrated in FIG. 24, the first partition 200A and the second partition 200B may be provided separately, only the first partition 200A may be provided so as to be movable in the left-right direction, and the second partition 200B may be fixed at a predetermined position. In such a configuration, for example, in the configuration in which the first play area PA1 and the second play area PA2 are not changed, only the left-right widths of the prize exhibit units 300A and 300B can be changed depending on the type of the prize placed in each play area. Furthermore, although not specifically illustrated in the drawings, the first partition 200A and the second partition 200B may be provided separately, only the second partition 200B may be provided so as to be movable in the left-right direction, and the first partition 200A may be fixed at a predetermined position. In such a configuration, the boundary of the play area can be partitioned in accordance with the left-right widths of the first play area PA1 and the second play area PA2 without changing the left-right widths of the prize exhibit units 300A and 300B.

Further, in the above embodiments, a configuration has been exemplified in which the lower part of the moving frame 213 of the first partition 200A constituting the partition body 200 can be fixed in position such that it is difficult to move in the left-right direction by the thumbscrews N4 and N4 of the attachment plate 241, but the present invention is not limited thereto, and the upper part of the first partition 200A constituting the partition body 200 may be fixed in position such that it is difficult to move in the left-right direction. For example, the upper part of the first partition 200A constituting the partition body 200 may be fixed by screwing, or, as illustrated in FIG. 25, recesses 215a each having a depth that allows the pair of left and right guide rollers 214, 214 to be accommodated therein and to ride over may be formed at a plurality of positions in the left-right direction on a bottom surface of the guide rail 215, so that movement of the guide rollers 214 and 214 in the left-right direction can be made difficult. Accordingly, by accommodating the guide rollers 214, 214 in the respective recesses 215a, the upper part of the first partition 200A constituting the partition body 200 can be fixed in position so that it is difficult for the upper part to move in the left-right direction. Further, as long as at least one of the upper part and the lower part of the first partition 200A constituting the partition body 200 can be fixed in position at a predetermined location of the accommodation portion 10, it is not necessary to perform processing on a member located at the rear side of the accommodation space in accordance with the position to which the partition body 200 has been moved, thereby improving the appearance of the rear side of the accommodation space.

Further, in the above embodiments, the first partition 200A of the partition body 200 has been suspended by the guide rail 215 so as to be movable in the left-right direction, but a location other than the upper part, such as the lower part of the partition body 200, may also be supported by a support member such as a guide rail so as to be movable in the left-right direction. In addition, neither the upper nor lower part of the partition body 200 needs to be supported by a support member so as to be movable in the left-right direction.

Further, in the above embodiments, a configuration has been exemplified in which the first partition 200A and the side holding bodies 201A and 201B are composed of plate-shaped members (or panels), such as the holding plates 211 and 231 in which the plurality of through-holes 220 is formed, but the present invention is not limited thereto, and may include, for example, a wire net in which metal wires are assembled in a lattice form, or by a pillar on which a plurality of hooks capable of holding the end portions of the prize support bodies is provided so as to protrude in the up-down direction.

Further, in the above embodiments, a configuration has been exemplified in which one partition body 200 is provided in the accommodation space to partition the play area into two sections in the left-right direction, but the present invention is not limited thereto, and two or more partition bodies may be provided in the accommodation space so that the play area can be partitioned into three or more sections. In addition, the partition body may be provided so as to partition the accommodation space into not only left and right sections, but also front and rear sections or top and bottom sections.

### [Prize Support Body]

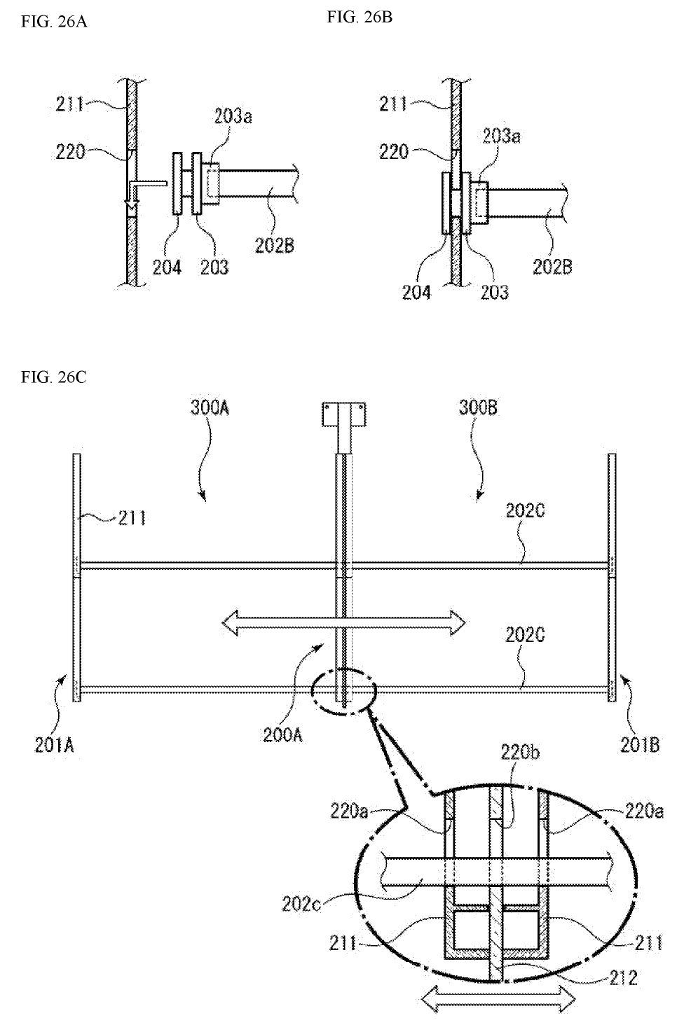

Further, in the above embodiments, a configuration has been exemplified in which the caps 203a each having the large-diameter flange portion 203 formed at the end portion thereof are attached to both end portions of the rod-shaped members 202A and 202B serving as prize support bodies, but the present invention is not limited thereto, and such caps are not necessarily required to be provided. Further, the large-diameter flange portion 203 serves to prevent the rod-shaped members 202A and 202B from falling out of the through-holes 220, and protrusion from the through-holes 220 has been restricted by the restriction pieces 221 formed in the holding plates 211 and 231, but the present invention is not limited thereto. For example, as illustrated in FIG. 26A, the pair of left and right flange portions 203 and 204 may be provided with a gap slightly larger than the thickness of the holding plates 211 and 231, and, as illustrated in FIG. 26B, the flange portions 203 and 204 may be locked so as to clamp a lower edge of an opening of the through-hole 220. In this way, it is possible to prevent the rod-shaped members 202A and 202B from falling out and protruding from the through-holes 220 without forming the restriction pieces 221 or the like on the holding plates 211 and 231.

Further, in the above embodiments, a configuration has been exemplified in which the rod-shaped members 202A and 202B serving as prize support bodies are separately held between the holding plate 211 of the first partition 200A and the holding plates 231 and 231 of the left and right side holding bodies 201A and 201B, but the present invention is not limited thereto. For example, as illustrated in FIG. 26C, the rod-shaped members 202c and 202c may be held between the left and right holding plates 231 and 231, and through-holes 220a, 220a, and 220b may be respectively formed in the holding plate 211 and the intermediate plate 212 of the first partition 200A, and, by inserting the rod-shaped members 202c and 202c through the through-holes 220a, 220a, and 220b, intermediate positions of the rod-shaped members 202c and 202c may be slidably held by the first partition 200A, which is movable in the left-right direction. In addition, the rod-shaped members 202c and 202c may be simply inserted without being held in place. In other words, the first partition 200A does not have to be used as a holding body of the prize support body. In addition, in such a configuration, the rod-shaped members 202c and 202c may be members that do not have elasticity.

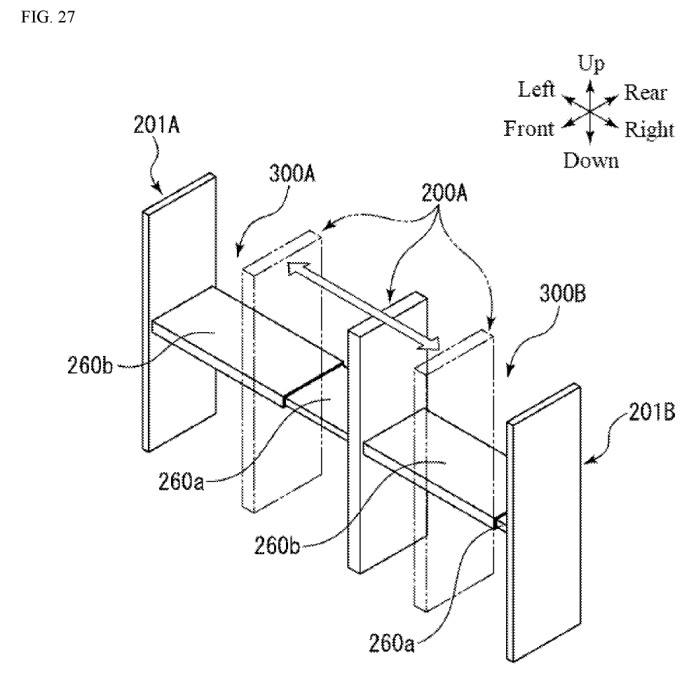

Further, in the above embodiments, a configuration has been exemplified in which the rod-shaped members 202A and 202B each formed of a tubular body are applied as an example of the prize support bodies, but the present invention is not limited thereto. For example, as illustrated in FIG. 27, the prize support bodies may be constituted by plate-shaped members 260a and 260b fitted so as to be extendable and retractable in the left-right direction, or may be constituted by a mesh member such as a net. Further, in the above embodiments, the rod-shaped members 202A and 202B serving as prize support bodies are installed between the first partition 200A and the left and right side holding bodies 201A and 201B, but the present invention is not limited thereto, and the rod-shaped members 202A and 202B are not necessarily required to be installed between the first partition 200A and the left and right side holding bodies 201A and 201B. For example, one end of each prize support body may be cantilevered and held by the side holding bodies 201A and 201B, the first partition 200A, or the transparent member 11e.

### [Prize]

Further, in the above embodiments, the prizes accommodated in the accommodation portion 10 are not limited to items that the player can directly acquire (for example, stuffed toys or the like), but also include items that are accommodated as targets for acquisition in the game and can be exchanged for other prizes after acquisition, and items that are not provided themselves but are used to compete for points or rankings.

### [Arm]

Further, in the above embodiments, the prize acquisition unit 20 having three arm portions 25 has been described as an example, but the present invention is not limited thereto. For example, the present invention can also be applied to a prize acquisition unit 20 having two or less arm portions 25 and a prize acquisition unit 20 having four or more arm portions 25.

### [Movable Actuating Unit]

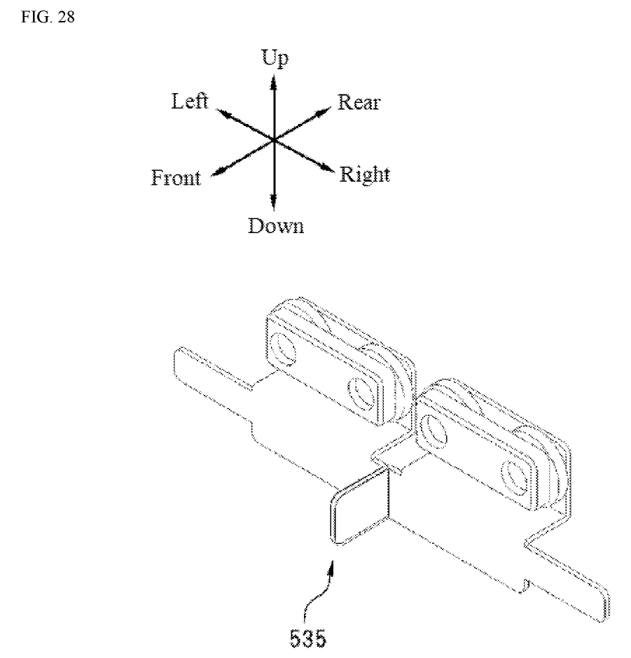

Further, in the above embodiments, an example has been described in which the first right end actuating unit 532 (or first actuating unit) and the second left end actuating unit 533 (or second actuating unit) can each slide along the fixed rail 53a to change their left-right positions. However, the present invention is not limited thereto. As illustrated in FIG. 28, an actuating unit 535 (or actuator) in which the first right end actuating unit 532 and the second left end actuating unit 533 are integrated may also be used.

In this case, the integrated actuating unit 535 is supported by the fixed rail 53a so as to be slidable between the first moving rail 54a1 and the second moving rail 54a2. The first right end sensor 54c2 (or first sensor) and the second left end sensor 54c3 (or second sensor) function as sensors that detect the boundary position between the first play area PA1 and the second play area PA2. Therefore, a service provider can change the size of the first play area PA1 and the second play area PA2 at the same time by adjusting the position of the integrated actuating unit along the fixed rail 53a in the left-right direction.

In addition, in the above embodiments, an example has been described in which the first right end actuating unit 532 and the second left end actuating unit 533 each have two wheels, but the present invention is not limited thereto. For example, the first right end actuating unit 532 and the second left end actuating unit 533, which do not have wheels, may each be configured to be slidably fitted into a groove on the inside of the front-side fixed rail 53a.

### [Movable Sensor]

In the above embodiments, the first right end sensor 54c2 and the second left end sensor 54c3 may each be configured to slide along the fixed rail 53a to change their positions in the left-right direction. In this case, a first right end actuating unit 532 is attached to the right front side of the first moving rail 54a1 in place of the first right end sensor 54c2, and a second left end actuating unit 533 is attached to the left front side of the second moving rail 54a2 in place of the second left end sensor 54c3. This enables a service provider to individually change the sizes of the first play area PA1 and the second play area PA2 by adjusting the left-right position of each of the first right end sensor 54c2 and the second left end sensor 54c3 along the fixed rail 53a.

The first right end sensor 54c2 and the second left end sensor 54c3 may be integrated into one body.

### [Front End Actuating Unit･Rear End Actuating Unit]

Further, in the above embodiments, it is also possible to enable the first front end actuating unit 541 and the first rear end actuating unit 542 to change their positions, respectively, in the front-rear direction along the first moving rail 54a1. In the same manner, it is also possible to enable the second front end actuating unit 543 and the second rear end actuating unit 544 to change their positions, respectively, in the front-rear direction along the second moving rail 54a2.

In this case, for example, a plurality of screw holes is formed at equal intervals along the front-rear direction in each of the first moving rail 54a1 and the second moving rail 54a2 so that the front end actuating unit and the rear end actuating unit can be attached at the changed positions.

### DESCRIPTION OF REFERENCE NUMERALS

1 Prize acquisition game device

10 Accommodation portion

11a to 11e Transparent member

12 Pillar portion

13 Upper horizontal frame material

14 Lower horizontal frame material

20 Prize acquisition unit

60 Placement portion

62 First prize placement portion

63 Second prize placement portion

71 Opening region

72 Drop port region

200 Partition body

200A First partition

200B Second partition

201A, 201B Side holding body (holding body)

202A, 202B Rod-shaped member (prize support body)

202c Non-extendable rod-shaped member (prize support body)

203 Flange portion (locking portion)

204 Flange portion (movement restriction portion)

211, 231 Holding plate

212 Intermediate plate

213, 253 Moving frame

214 Guide roller

215 Guide rail

217, 257 Light-emitting diode

220 Through-hole (hole portion)

220a, 220b Through-holes (hole portion)

221 Restriction piece (movement restriction portion)

243, 259 Screw hole

251 Partition plate

260a, 260b Plate-shaped member (prize support body)

300A, 300B Prize exhibit unit

DA Non-play area

PA1 First play area

PA2 Second play area

What is claimed is:

1. A prize acquisition game device that allows a player to play a game to acquire a prize accommodated in an accommodation space, the prize acquisition game device comprising:
a prize catcher that catches the prize accommodated in the accommodation space; and
a prize exhibit unit that is disposed inside and at a rear portion of the accommodation space to display the prize, and that comprises:
a partition body that partitions the accommodation space in a left-right direction of the prize acquisition game device and is configured to be movable in the left-right direction.

2. The prize acquisition game device according to claim 1, wherein
the accommodation space includes, in addition to the prize exhibit unit disposed at the rear portion, a play area disposed at a front portion of the accommodation space, and
the partition body partitions, in the left-right direction, at least the prize exhibit unit in the accommodation space.

3. The prize acquisition game device according to claim 2, wherein
the partition body includes:
a first partition extending in an up-down direction of the prize acquisition game device to partition the prize exhibit unit, and
a second partition extending in a front-rear direction of the prize acquisition game device to partition the play area.

4. The prize acquisition game device according to claim 1, wherein
the partition body is fixed at a rear upper part or a rear lower part of the accommodation space.

5. The prize acquisition game device according to claim 4, wherein
a guide rail extending in the left-right direction is disposed at the rear upper part of the accommodation space, and
an upper part of the partition body is slidably suspended from the guide rail.

6. The prize acquisition game device according to claim 1, wherein
the prize exhibit unit further comprises a prize support body having one end supported by the partition body, and
the prize support body is formed of a member having a length that is adjustable in the left-right direction.

7. The prize acquisition game device according to claim 6, wherein
the prize support body is a rod-shaped member that is extendable and retractable in the left-right direction.
